(19) United States
(12) Patent Application Publication
(10) Pub. No.: US 2025/0231377 A1
(43) Pub. Date: Jul. 17, 2025

(54) OPTICAL IMAGING LENS, IMAGING DEVICE AND ELECTRONIC DEVICE

(71) Applicants: ETERGE OPTO-ELECTRONICS CO., LTD., Taichung City (TW); ZHONG YANG TECHNOLOGY CO., LTD., Taichung City (TW)

(72) Inventors: CHIH-CHENG HSU, Taichung City (TW); CHIA-YI KO, Taichung City (TW); TSU-MENG LEE, Taichung City (TW)

(21) Appl. No.: 19/004,616

(22) Filed: Dec. 30, 2024

(30) Foreign Application Priority Data
Jan. 17, 2024 (TW) 113101926

(51) Int. Cl. G02B 13/00; G02B 9/58

(52) U.S. Cl. CPC G02B 13/004; G02B 9/58; G02B 13/0055

(57) ABSTRACT

An optical imaging lens including a first lens, a second lens, an aperture, a third lens and a fourth lens arranged in sequence from an object side to an image side along an optical axis. The optical imaging lens includes, from an object side to an image side, the first lens having negative refractive power and including an image-side surface being concave, the second lens having positive refractive power and including an image-side surface being convex, the third lens having refractive power and including an object-side surface being convex and the fourth lens having refractive power. The optical imaging lens includes a total of four lenses.

### BACKGROUND OF INVENTION

This invention relates to an optical imaging lens and imaging device, particularly an optical imaging lens suitable for general electronic devices, automotive electronic devices or vehicle recording devices, and an imaging device and electronic device equipped with such an optical imaging lens.

### PRIOR ART

With advancements in semiconductor manufacturing processes, image sensors in photographic devices (e.g., CCD and CMOS Image Sensors) can meet the requirements for miniaturization, facilitating the production of miniaturized cameras. This trend has driven digital electronic products to incorporate miniaturized cameras for imaging functionality. Beyond the trend of miniaturization, photographic devices also need to meet consumer usage requirements for higher resolution, superior lens specifications (e.g., larger aperture ratios, wider field of view), and reduced manufacturing costs.

With the diversified development of electronic imaging devices, their applications have become increasingly broad, including advanced driver-assistance systems (ADAS), dash cameras, home surveillance equipment, smartphones, and human-machine interaction devices. As a result, the design requirements for optical lenses have also become increasingly diverse. For automotive imaging devices, to accurately identify objects or human behaviors and actions inside and outside the vehicle, it is necessary to enhance the resolution and brightness of optical lenses while ensuring a high level of adaptability to temperature variations of environment. Furthermore, to effectively correct various aberrations, particularly for applications such as distance measurement or object recognition, significant distortion aberrations present in captured images can result in errors during distance calculation or image recognition.

Therefore, designing an optical imaging device that achieves a balance among miniaturization, high resolution, and excellent optical imaging quality has become a primary objective for those skilled in the art.

### SUMMARY OF THE INVENTION

According to one aspect of the present disclosure, an optical imaging lens, in order from an object side to an image side, comprises a first lens with negative refractive power, a second lens with positive refractive power, an aperture stop, a third lens with refractive power, and a fourth lens with refractive power. The first lens has an image-side surface being concave. The second lens with positive refractive power has an image-side surface being convex. The third lens has an object-side surface being convex. A thickness of the second lens is CT2, a thickness of the third lens is CT3, an air gap from the second lens to the third lens is AT23, a thickness of the fourth lens is CT4, an air gap from the third lens to the fourth lens is AT34, and the following conditions are satisfied: −7.3<(CT2−CT3)/AT23<−0.8; and −0.3<(CT3−CT4)/AT34<1.7.

According to another aspect of the present disclosure, a focal length of the the third lens is f3, a focal length of the optical imaging lens is EFL, a focal length of the fourth lens is f4, and the following condition is satisfied: −3.7<(f3+f4)/EFL<−0.02.

According to another aspect of the present disclosure, a curvature radius of an object-side surface of the the second lens is R3, a curvature radius of the image-side of the the second lens is R4, and the following condition is satisfied: −3.1<R3/R4<2.5.

According to another aspect of the present disclosure, a focal length of the second lens is f2, a focal length of the optical imaging lens is EFL, and the following condition is satisfied: 0.9<f2/EFL<8.8.

According to another aspect of the present disclosure, a curvature radius of the image-side of the the second lens is R4, a focal length of the second lens is f2, and the following condition is satisfied:

$$- 1.3 < R 4 / f 2 < - 0.07 .$$

According to another aspect of the present disclosure, a curvature radius of an object-side surface of the the second lens is R3, a curvature radius of the image-side of the the second lens is R4, a focal length of the second lens is f2, and the following condition is satisfied: −0.8<(R3−R4)/f2<2.8.

According to another aspect of the present disclosure, a thickness of the first lens is CT1, a thickness of the second lens is CT2, an air gap from the first lens to the second lens is AT12, and the following condition is satisfied: −0.4<(CT1−CT2)/AT12<0.8.

According to another aspect of the present disclosure, a focal length of the third lens is f3, a focal length of the optical imaging lens is EFL, and the following condition is satisfied: −5.5<f3/EFL<1.8.

According to another aspect of the present disclosure, a focal length of the first lens is f1, a focal length of the second lens is f2, a focal length of the optical imaging lens is EFL, and the following condition is satisfied: −0.1<(f1+f2)/EFL<7.

According to another aspect of the present disclosure, a total track length of the optical imaging lens is TTL, a thickness of the first lens is CT1, and the following condition is satisfied: 4.7<TTL/CT1<18.

According to another aspect of the present disclosure, a focal length of the second lens is f2, a maximum image height of the optical imaging lens is ImgH, and the following condition is satisfied:

$$1.7 < f 2 / ImgH < 15.$$

According to another aspect of the present disclosure, a focal length of the third lens is f3, a maximum image height of the optical imaging lens is ImgH, and the following condition is satisfied:

$$- 9 < f 3 / ImgH < 3.8 .$$

According to another aspect of the present disclosure, a maximum image height of the optical imaging lens is ImgH, a focal length of the optical imaging lens is EFL, and the following condition is satisfied: 0.4<ImgH/EFL<0.8.

According to another aspect of the present disclosure, the Abbe number of the first lens is Vd1, the Abbe number of the third lens is Vd3, the Abbe number of the fourth lens is Vd4, and the following condition is satisfied: −0.7<(Vd3−Vd4)/Vd1<0.8.

According to another aspect of the present disclosure, the optical imaging lens comprises one of the following conditions: an object-side surface of the first lens being convex, an object-side surface of the second lens being concave, an image-side surface of the third lens being convex, the third lens having positive refractive power, and the fourth lens having negative refractive power.

According to another aspect of the present disclosure, the optical imaging lens comprises one of the following conditions: an object-side surface of the fourth lens being concave, and an image-side surface of the fourth lens being convex.

According to another aspect of the present disclosure, the optical imaging lens comprises one of the following conditions: an object-side surface of the fourth lens being convex, and an image-side surface of the fourth lens being concave.

According to another aspect of the present disclosure, the optical imaging lens comprises one of the following conditions: the third lens having negative refractive power, the fourth lens having positive refractive power, and an object-side surface of the first lens being a flat surface.

The present disclosure further provides an imaging device including the optical imaging lens as mentioned above and an electronic image sensor. The electronic image sensor is located on an image plane of the optical imaging lens.

The present disclosure provides an electronic device including the imaging device as mentioned above.

### BRIEF DESCRIPTION OF THE DRAWINGS

FIG. 1A is a schematic view of an optical imaging lens according to a first embodiment of the present disclosure;

FIG. 1B shows the astigmatism/field curvature curves, the distortion curves and the longitudinal spherical aberration curves of the optical imaging lens according to the first embodiment of the present disclosure;

FIG. 2A is a schematic view of an optical imaging lens according to a second embodiment of the present disclosure;

FIG. 2B shows the astigmatism/field curvature curves, the distortion curves and the longitudinal spherical aberration curves of the optical imaging lens according to the second embodiment;

FIG. 3A is a schematic view of an optical imaging lens according to a third embodiment of the present disclosure;

FIG. 3B shows the astigmatism/field curvature curves, the distortion curves and the longitudinal spherical aberration curves of the optical imaging lens according to the third embodiment;

FIG. 4A is a schematic view of an optical imaging lens according to a fourth embodiment of the present disclosure;

FIG. 4B shows the astigmatism/field curvature curves, the distortion curves and the longitudinal spherical aberration curves of the optical imaging lens according to the fourth embodiment;

FIG. 5A is a schematic view of an optical imaging lens according to a fifth embodiment of the present disclosure;

FIG. 5B shows the astigmatism/field curvature curves, the distortion curves and the longitudinal spherical aberration curves of the optical imaging lens according to the fifth embodiment;

FIG. 6A is a schematic view of an optical imaging lens according to a sixth embodiment of the present disclosure;

FIG. 6B shows the astigmatism/field curvature curves, the distortion curves and the longitudinal spherical aberration curves of the optical imaging lens according to the sixth embodiment;

FIG. 7A is a schematic view of an optical imaging lens according to a seventh embodiment of the present disclosure;

FIG. 7B shows the astigmatism/field curvature curves, the distortion curves and the longitudinal spherical aberration curves of the optical imaging lens according to the seventh embodiment;

FIG. 8A is a schematic view of an optical imaging lens according to eighth embodiment of the present disclosure;

FIG. 8B shows the astigmatism/field curvature curves, the distortion curves and the longitudinal spherical aberration curves of the optical imaging lens according to the eighth embodiment;

FIG. 9 is a schematic view of an automotive electronic device according to a ninth embodiment of the present disclosure;

FIG. 10 is a schematic view of a general electronic device according to a ninth embodiment of the present disclosure;

### DETAILED DESCRIPTION OF THE INVENTION

In the following embodiments, the lenses of any optical imaging lens may be made of glass or plastic, without being limited to the materials specified in the embodiments. When the lens material is glass, the lens surface can be processed by grinding or molding. Additionally, glass material is resistant to temperature variations and with high hardness, which can reduce the impact of environmental changes on the optical imaging lens and thereby extend its lifespan. When the lens material is plastic, it helps reduce the weight of the optical imaging lens and lower production costs.

In the embodiments of the present invention, each lens includes an object-side surface, facing the imaged object, and an image-side surface, facing the image plane. The surface shape of each lens is defined based on the shape of the surface near to the optical axis (paraxial region). For example, if the object-side surface of a lens is described as convex, it means that the object-side surface of the lens near to the optical axis is convex, although the surface in the off-axis region may be either convex or concave. The paraxial region shape of the each lens is determined by whether the curvature radius of the surface is positive or negative. For instance, if the curvature radius of the object-side surface of a lens is positive, the object-side surface is convex, while if the curvature radius of the object-side surface of a lens is negative, the object-side surface is concave; if the curvature radius of the image-side surface of a lens is positive, the image-side surface is concave, while if the curvature radius of the image-side surface of a lens is negative, the image-side surface is convex.

In the embodiments of the present invention, the object-side surface and the image-side surface of each lens can be spherical or aspherical. Using aspherical surfaces on lenses helps correct aberrations of the optical imaging lens, such as spherical aberration, and reduces the number of lenses used. However, incorporating aspherical lenses increases the overall cost of the optical imaging lens. In the embodiments of the present invention, the surfaces of some lenses are spherical but can be modified to aspherical as needed; similarly, the surfaces of some lenses are aspherical but it can be modified to spherical as needed.

In the embodiments of the present invention, the total track length (TTL) of the optical imaging lens is defined as the distance from the object-side surface of the first lens of the optical imaging lens to the image plane on the optical axis. The imaging height of the optical imaging lens, also called the maximum image height (ImgH). While an electronic image sensor is installed on the image plane, ImgH represents half the diagonal length of the effective sensing area of the electronic image sensor. In the following embodiments, the TTL, ImgH, focal length, curvature radius of lenses, thickness of lenses, and the distances among each lens are measured in mm.

An optical imaging lens of the present invention, in order from an object side to an image side, comprises a first lens, a second lens, an aperture stop, a third lens, and a fourth lens.

The first lens has a negative refractive power. Its object-side surface can be convex or flat while its image-side surface is concave, enhancing application flexibility. Preferably, the first lens is made of glass for the environment with huge temperature difference. In the embodiment of the present invention, the object-side surface or/and image-side surface of the first lens can be spherical to lower production cost and facilitate processing.

The second lens has a positive refractive power. Its object-side surface can be convex or concave while its image-side surface is convex. The second lens can be combined with other materials to increase design flexibility, in order to meet actual needs, helping expand imaging field of view and increase light gathering range of the optical imaging lens. Preferably, the material of the second lens can be glass or plastic. In the embodiments of the present invention, the object-side surface or/and image-side surface of the second lens can be spherical or aspherical.

The third lens may have either a positive or negative refractive power. Its object-side surface is convex, while the image-side surface may be either convex or concave, or approximately flat. By utilizing the convex object-side surface of the third lens and the flexible image-side surface (either convex, concave, or nearly flat), the imaging field of view can be expanded, the light gathering range of the optical imaging lens can be increased, and the distortion aberration can be controlled in terms of size and direction. Preferably, the material of the third lens can be glass or plastic. In the embodiment of the present invention, the object-side surface and/or the image-side surface of the third lens can be aspherical.

The fourth lens may have either a positive or negative refractive power. Its object-side surface may be convex or concave, and the image-side surface may also be convex or concave. The refractive power of the fourth lens works in conjunction with the third lens, helping to reduce imaging aberrations, and it can be paired with other materials to increase design flexibility. Preferably, the material of the fourth lens can be plastic to reduce manufacturing costs and facilitate processing. In the embodiment of the present invention, the object-side surface and/or the image-side surface of the fourth lens can be aspherical, which can help to improve spherical aberration.

The focal length of the third lens in the optical imaging lens is f3, and the focal length of the optical imaging lens is EFL. The optical imaging lens satisfies the following condition:

$$- 5.5 < f 3 / EFL < 1.8 . \qquad ( 1 )$$

When the condition (1) is satisfied, the size and field of view (FOV) of the optical imaging lens can be controlled.

The focal length of the first lens in the optical imaging lens is f1, the focal length of the second lens is f2, and the focal length of the optical imaging lens is EFL. The optical imaging lens satisfies the following condition:

$$- 0.1 < ( f 1 + f 2 ) / EFL < 7. \qquad ( 2 )$$

When the condition (2) is satisfied, the size and field of view (FOV) of the optical imaging lens can be controlled.

The focal length of the third lens in the optical imaging lens is f3, the focal length of the fourth lens is f4, and the focal length of the optical imaging lens is EFL. The optical imaging lens satisfies the following condition:

$$- 3.7 < ( f 3 + f 4 ) / EFL < - 0 \text{.02} . \qquad ( 3 )$$

When the condition (3) is satisfied, the size of the field curvature can be controlled.

The curvature radius of the object-side surface of the the second lens in the optical imaging lens is R3, and the curvature radius of the image-side of the the second lens is R4. The optical imaging lens satisfies the following condition:

$$- 3.1 < R 3 / R 4 < 2.5 . \qquad ( 4 )$$

When the condition (4) is satisfied, the lateral chromatic aberration can be controlled.

The focal length of the second lens in the optical imaging lens is f2, and the focal length of the optical imaging lens is EFL. The optical imaging lens satisfies the following condition:

$$0.9 < f 2 / EFL < 8.8 . \qquad ( 5 )$$

When the condition (5) is satisfied, the second lens will have an appropriate positive refractive power so as to help balance the negative refractive power of the first lens and adjust the direction of light.

The curvature radius of the image-side of the the second lens in the optical imaging lens is R4, and the focal length of the second lens is f2. The optical imaging lens satisfies the following condition:

$$- 1.3 < R 4 / f 2 < - 0 \text{.07} . \qquad ( 6 )$$

When the condition (6) is satisfied, the surface shape and refractive power of the second lens can be adjusted, which is favorable for correcting aberrations.

The curvature radius of the object-side surface of the the second lens in the optical imaging lens is R3, the curvature radius of the image-side of the the second lens is R4, and the focal length of the second lens is f2. The optical imaging lens satisfies the following condition:

$$- 0.8 < ( R 3 - R 4 ) / f 2 < 2.8 . \qquad ( 7 )$$

When the condition (7) is satisfied, the second lens will have an appropriate shape, which is favorable for reducing aberrations.

The thickness of the first lens in the optical imaging lens is CT1, the thickness of the second lens is CT2, and the air gap from the first lens to the second lens is AT12. The optical imaging lens satisfies the following condition:

$$- 0.4 < ( CT 1 - CT 2 ) / AT 12 < 0.8 . \qquad ( 8 )$$

When the condition (8) is satisfied, the first lens will work in conjunction with the second lens, helping to adjust field of view. Therefore, it is favorable for correcting aberrations of the optical imaging lens and improving the imaging quality of the optical imaging lens.

The thickness of the second lens in the optical imaging lens is CT2, the thickness of the third lens is CT3, and the air gap from the second lens to the third lens is AT23. The optical imaging lens satisfies the following condition:

$$- 7.3 < ( CT 2 - CT 3 ) / AT 23 < - 0.8 . \qquad ( 9 )$$

When the condition (9) is satisfied, the second lens will work in conjunction with the third lens to correct the aberrations of the optical imaging lens and thereby improving the imaging quality of the optical imaging lens.

The thickness of the third lens in the optical imaging lens is CT3, the thickness of the fourth lens is CT4, the air gap from the third lens to the fourth lens is AT34. The optical imaging lens satisfies the following condition:

$$- 0.3 < ( CT 3 - CT 4 ) / AT 34 < 1.7 . \qquad ( 10 )$$

When the condition (10) is satisfied, the third lens will work in conjunction with the fourth lens to correct the aberrations of the optical imaging lens and thereby improving the imaging quality of the optical imaging lens.

The total track length of the optical imaging lens is TTL, and a thickness of the first lens is CT1. The optical imaging lens satisfies the following condition:

$$4.7 < TTL / CT 1 < 18. \qquad ( 11 )$$

When the condition (11) is satisfied, the ratio of the overall length of the optical imaging lens and the thickness of the first lens along the optical axis can be controlled, which helps maintain the miniaturization of the optical imaging lens.

The focal length of the second lens is f2 in the optical imaging lens, and a maximum image height of the optical imaging lens is ImgH. The optical imaging lens satisfies the following condition:

$$1.7 < f 2 / ImgH < 15. \qquad ( 12 )$$

When the condition (12) is satisfied, by controlling the relationship between the effective focal length of the second lens and the image plane helps optimizing the aberrations of the optical imaging lens.

The focal length of the third lens is f3 in the optical imaging lens, and a maximum image height of the optical imaging lens is ImgH. The optical imaging lens satisfies the following condition:

$$- 9 < f 3 / ImgH < 3.8 . \qquad ( 13 )$$

When the condition (13) is satisfied, it helps reduce the aberrations of the optical imaging lens, ensuring the imaging quality of the optical imaging lens.

The maximum image height of the optical imaging lens is ImgH, the focal length of the optical imaging lens is EFL, which satisfies the following condition:

$$0.4 < ImgH / EFL < 0.8 . \qquad ( 14 )$$

When the condition (14) is satisfied, the optical imaging lens is able to achieve an appropriate field of view and improves assembly flexibility, thereby reducing the manufacturing complexity of the lens assembly.

The Abbe number of the first lens is Vd1, the Abbe number of the third lens is Vd3, and the Abbe number of the fourth lens is Vd4. The optical imaging lens satisfies the following condition:

$$- 0.7 < ( Vd 3 - Vd 4 ) / Vd 1 < 0. 8 . \qquad ( 15 )$$

When the condition (15) is satisfied, the third and fourth lenses will have sufficient image control capability to correct various aberrations.

### First Embodiment

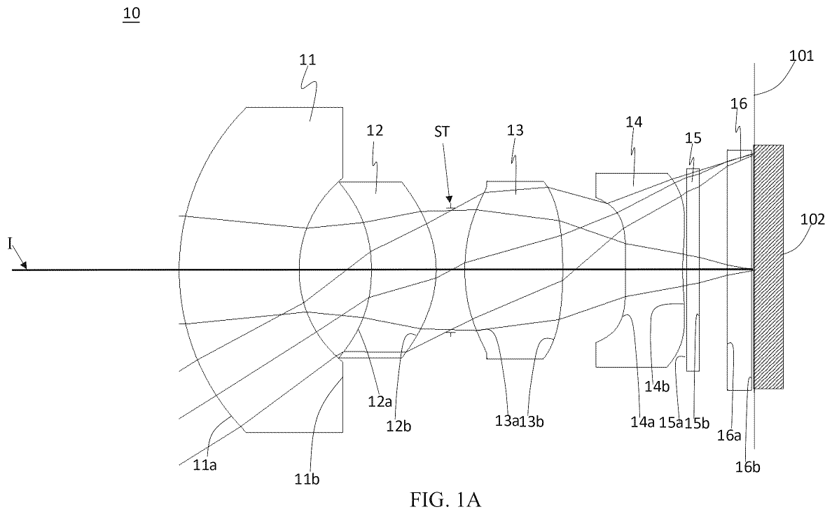

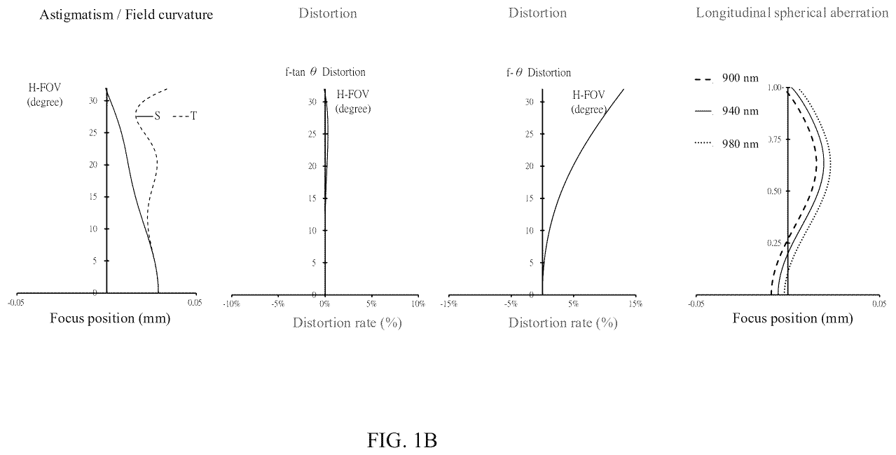

FIG. 1A is a schematic view of an optical imaging lens of a first embodiment according to the present invention. FIG. 1B, from left to right, shows the astigmatism/field curvature curves, f-tan θ distortion curves, f-θ distortion curves and the longitudinal spherical aberration curves of the optical imaging lens according to the first embodiment.

As shown in FIG. 1A, the optical imaging lens 10 of the first embodiment includes, in order from an object side to an image side, a first lens 11, a second lens 12, an aperture stop ST, a third lens 13 and a fourth lens 14. The optical imaging lens 10 may further include a filter unit 15, a protective glass 16 and an image plane 101. An electronic image sensor 102 could be disposed on the image plane 101 of the optical imaging lens 10 to form an imaging device (not labeled).

The first lens 11 has negative refractive power. Its object-side surface 11a is convex while its image-side surface 11b is concave. Both of the object-side surface 11a and the image-side surface 11b are spherical. The material of the first lens 11 includes glass, but is not limited thereto.

The second lens 12 has positive refractive power. Its object-side surface 12a is concave while its image-side surface 12b is convex. Both of the object-side surface 12a and the image-side surface 12b are aspheric. The material of second lens 12 includes plastic, but is not limited thereto.

The third lens 13 has positive refractive power. Its object-side surface 13a is convex and its image-side surface 13b is convex. Both of the object-side surface 13a and the image-side surface 13b are aspheric. The material of third lens 13 includes glass, but is not limited thereto.

The fourth lens 14 has negative refractive power. Its object-side surface 14a is concave while its image-side surface 14b is convex. Both of the object-side surface 14a and the image-side surface 14b are aspheric. The material of the fourth lens 14 includes plastic, but is not limited thereto.

The filter unit 15 is positioned between the fourth lens 14 and the image plane 101 to filter out light of specific wavelength ranges, allowing the desired wavelengths to pass through. For example, it can be a component for filtering ultraviolet or far-infrared light. Both surfaces 15a and 15b of the filter unit 15 are flat, and the material is glass.

The protective glass 16 is positioned between the filter unit 15 and the image plane 101 to protect the image plane 101. Both surfaces 16a and 16b of the protective glass 16 are flat, and the material is glass.

The electronic image sensor 102 can be a CCD image sensor or CMOS image sensor.

The aspherical shapes of the above lens surfaces are expressed by the following equation (1):

$$X ( Y ) = {CY}^{2} / ( 1 + \sqrt{1 - ( 1 + K ) {C}^{2} {Y}^{2}} ) + {\sum }_{i = 2 x}^{n} {A}_{i} \times {Y}^{i}$$

wherein,
X: the displacement of a point on the aspheric lens surface at a distance Y from the optical axis relative to the tangential plane at the aspheric surface vertex;
Y: the distance from the point on the curve of the aspheric surface to the optical axis;
C: the reciprocal of the curvature radius in paraxial region of lens;
K: the conic coefficient; and
Ai: the aspheric surface coefficient of order i, wherein i=2x, and x is a natural number greater than or equal to 2, meaning i is an even number greater than or equal to 4.

Referring to Table 1, which provides the optical parameters of the optical imaging lens 10 of the first embodiment. In Table 1, the object-side surface 11a of the first lens 11 is denoted as surface 11a, the image-side surface 11b is denoted as surface 11b, and so on. The value in the distance column denotes a distance from a lens surface to a next lens surface on the optical axis I. For example, the distance from the object-side surface 11a to the image-side surface 11b is 2.013 mm, which means that a thickness of the first lens 11 is 2.013 mm. Similarly, the distance AT12 from the image-side surface 11b of the first lens 11 to the object-side surface 12a of the second lens 12 is 1.216 mm, and so on. In the first embodiment, the effective focal length of the optical imaging lens 10 is EFL, the maximum half field of view of the optical imaging lens 10 is HFOV. The values of HFOV of the optical imaging lens 10 are listed in Table 1.

TABLE 1
First Embodiment
TTL = 9.65 mm, EFL = 3.42 mm, FNO = 1.9, HFOV = 32°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 11a | Spherical | 3.869 | 2.013 | 1.729 | 54.7 | −10.5 |
| | | Surface | | | | | |
| | 11b | Spherical | 1.999 | 1.216 | | | |
| | | Surface | | | | | |
| 2nd lens | 12a | Aspherical | −2.528 | 1.085 | 1.537 | 56.0 | 8.5 |
| | | Surface | | | | | |
| | 12b | Aspherical | −1.854 | 0.250 | | | |
| | | Surface | | | | | |
| Aperture | ST | Flat | Infinity | 0.232 | | | |
| Stop | | Surface | | | | | |
| 3rd lens | 13a | Aspherical | 2.889 | 1.645 | 1.619 | 63.9 | 3.6 |
| | | Surface | | | | | |
| | 13b | Aspherical | −7.140 | 1.056 | | | |
| | | Surface | | | | | |
| 4th lens | 14a | Aspherical | Infinity | 0.960 | 1.661 | 20.4 | −7.9 |
| | | Surface | | | | | |
| | 14b | Aspherical | 5.065 | 0.068 | | | |
| | | Surface | | | | | |
| Filter Unit | IR object- | Flat | Infinity | 0.210 | 1.517 | 64.2 | inf |
| | side | Surface | | | | | |
| | surface | | | | | | |
| | IR image- | Flat | Infinity | 0.471 | | | |
| | side | Surface | | | | | |
| | surface | | | | | | |
| CG | CG object- | Flat | Infinity | 0.400 | 1.517 | 64.2 | inf |
| | side | Surface | | | | | |
| | surface | | | | | | |
| | CG image- | Flat | Infinity | 0.050 | | | |
| | side | Surface | | | | | |
| | surface | | | | | | |
| Image Plane | | Flat | Infinity | 0.000 | | | |
| | | Surface | | | | | |

Reference Wavelength: 940 nm

Table 2 below lists the values of the aspherical surface coefficients of each lens surface in the first embodiment used. Wherein K is the conic coefficient of the aspherical curve equation, and A₄ to A₁₀ are the 4nd order to the 10th order aspheric coefficients. For example, the conic coefficient K of the object-side surface 11a of the first lens 11 is −2.03E+00, and so on. In the following description, the tables for each of the optical imaging lenses of other embodiments use the same definition as the first embodiment. Therefore, the duplicated description would be omitted for brevity.

TABLE 2
First Embodiment_Aspherical Surface Coefficient

| | 12a | 12b | 13a | 13b | 14a | 14b |
|---|---|---|---|---|---|---|
| K | −2.03E+00 | −2.37E+00 | −1.59E+00 | 1.56E+01 | 0.00E+00 | −7.06E−01 |
| A4 | −4.43E−02 | −2.14E−02 | 2.37E−02 | −2.18E−02 | −1.37E−01 | −8.45E−02 |
| A6 | 4.70E−03 | 2.36E−03 | −8.76E−04 | −3.41E−05 | −1.91E−02 | 7.79E−03 |
| A8 | −9.15E−05 | −1.37E−03 | −3.96E−03 | 1.31E−03 | −5.44E−03 | −3.56E−03 |
| A10 | 2.23E−04 | 5.37E−04 | 5.73E−04 | −8.98E−04 | −1.60E−02 | 7.18E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the first embodiment, the focal length of the third lens in the optical imaging lens is f3, the focal length of the optical imaging lens is EFL, f3/EFL=1.058.

In the first embodiment, the focal length of the optical imaging lens is EFL, the focal length of the first lens in the optical imaging lens is f1, the focal length of the second lens in the optical imaging lens is f2, (f1+f2)/EFL=−0.596.

In the first embodiment, the focal length of the third lens in the optical imaging lens is f3, the focal length of the fourth lens in the optical imaging lens is f4, the focal length of the optical imaging lens is EFL, (f3+f4)/EFL=−1.263.

In the first embodiment, the curvature radius of the object-side surface of the the second lens in the optical imaging lens is R3, and the curvature radius of the image-side of the the second lens is R4, R3/R4=1.364.

In the first embodiment, the focal length of the second lens in the optical imaging lens is f2, and the focal length of the optical imaging lens is EFL, f2/EFL=2.474.

In the first embodiment, the curvature radius of the image-side of the second lens in the optical imaging lens is R4, and the focal length of the second lens is f2, R4/f2=−0.219.

In the first embodiment, the curvature radius of the object-side surface of the the second lens in the optical imaging lens is R3, the curvature radius of the image-side of the the second lens is R4, and the focal length of the second lens is f2, (R3−R4)/f2=−0.080.

In the first embodiment, the thickness of the first lens in the optical imaging lens is CT1, the thickness of the second lens is CT2, the air gap from the first lens to the second lens is AT12, (CT1−CT2)/AT12=0.763.

In the first embodiment, the thickness of the second lens in the optical imaging lens is CT2, the thickness of the third lens is CT3, the air gap from the second lens to the third lens is AT23, (CT2−CT3)/AT23=−1.163.

In the first embodiment, the thickness of the third lens in the optical imaging lens is CT3, the thickness of the fourth lens is CT4, the air gap from the third lens to the fourth lens is AT34, (CT3−CT4)/AT34=0.416.

In the first embodiment, the total track length of the optical imaging lens is TTL, and a thickness of the first lens is CT1, TTL/CT1=4.793.

In the first embodiment, the focal length of the second lens is f2 in the optical imaging lens, and a maximum image height of the optical imaging lens is ImgH, f2/ImgH=4.338.

In the first embodiment, the focal length of the third lens is f3 in the optical imaging lens, and a maximum image height of the optical imaging lens is ImgH, f3/ImgH=1.856.

In the first embodiment, the maximum image height of the optical imaging lens is ImgH, the focal length of the optical imaging lens is EFL, ImgH/EFL=0.570.

In the first embodiment, the Abbe number of the first lens is Vd1, the Abbe number of the third lens is Vd3, and the Abbe number of the fourth lens is Vd4, (Vd3−Vd4)/Vd1=0.795.

According from the above-described values, the optical imaging lens 10 of the first embodiment satisfies the requirements of conditions (1) to (15).

FIG. 1B shows, from left to right, the astigmatism/field curvature curves, f-tan θ distortion curves, f-θ distortion curves and the longitudinal spherical aberration curves of the optical imaging lens 10. It can be seen from the astigmatism/field curvature curve (wavelength 940 nm), the aberration in the sagittal direction (S) varies between 0.00 and 0.03 mm across the entire field of view, while the aberration in the tangential direction (T) varies between 0.02 and 0.03 mm. From the f-tan θ distortion curve (wavelength 940 nm), it is evident that the absolute value of the f-tan θ distortion rate of the optical imaging lens 10 is less than 0%. From the f-θ distortion curve (wavelength 940 nm), it can be observed that the absolute value of the f-θ distortion rate of the optical imaging lens 10 is less than 13%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of-0.01 to 0.02 mm. As shown in FIG. 1B, the optical imaging lens 10 of this embodiment has effectively corrected various aberrations, meeting the imaging quality requirements of the optical system.

### Second Embodiment

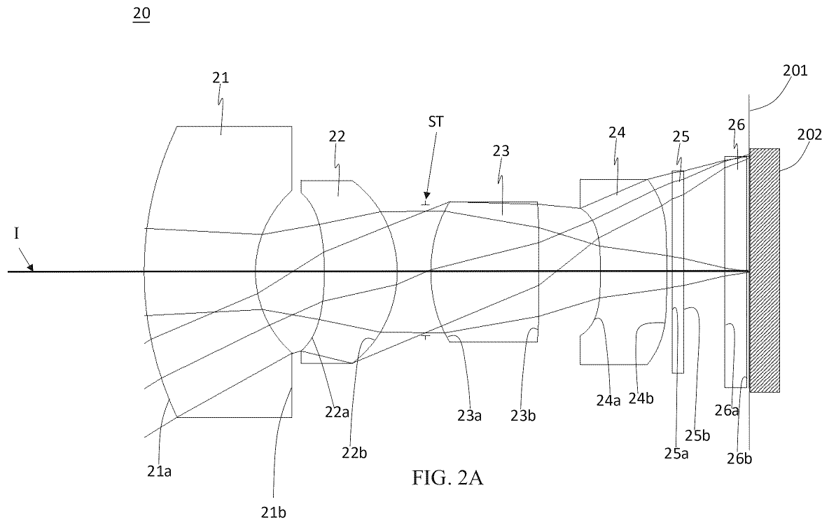

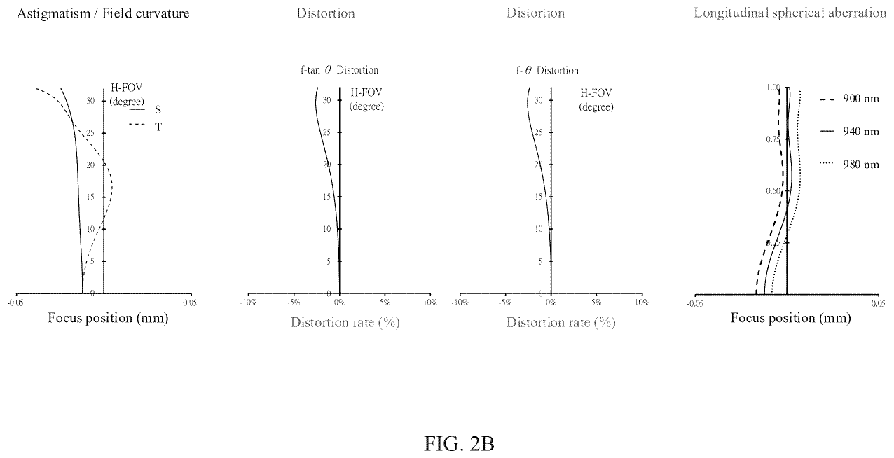

Referring to FIGS. 2A and 2B, FIG. 2A is a schematic view of an optical imaging lens of a second embodiment according to the present invention. FIG. 2B, from left to right, shows the astigmatism/field curvature curves, f-tan θ distortion curves, f-θ distortion curves and the longitudinal spherical aberration curves of the optical imaging lens according to the second embodiment.

As shown in FIG. 2A, the optical imaging lens 20 of the second embodiment includes, in order from an object side to an image side, a first lens 21, a second lens 22, an aperture stop ST, a third lens 23 and a fourth lens 24. The optical imaging lens 20 may further include a filter unit 25, a protective glass 26 and an image plane 201. An electronic image sensor 202 can be disposed on the image plane 201 of the optical imaging lens 20 to form an imaging device (not labeled).

The first lens 21 has negative refractive power. Its object-side surface 21a is convex while its image-side surface 21b is concave. Both of the object-side surface 21a and the image-side surface 21b are spherical. The material of the first lens 21 includes glass, but is not limited thereto.

The second lens 22 has positive refractive power. Its object-side surface 22a is concave while its image-side surface 22b is convex. Both of the object-side surface 22a and the image-side surface 22b are aspheric. The material of second lens 22 includes plastic, but is not limited thereto.

The third lens 23 has positive refractive power. Its object-side surface 23a is convex and its image-side surface 23b is convex. Both of the object-side surface 23a and the image-side surface 23b are aspheric. The material of third lens 23 includes glass, but is not limited thereto.

The fourth lens 24 has negative refractive power. Its object-side surface 24a is concave while its image-side surface 24b is convex. Both of the object-side surface 24a and the image-side surface 24b are aspheric. The material of the fourth lens 24 includes plastic, but is not limited thereto.

The filter unit 25 is positioned between the fourth lens 24 and the image plane 201 to filter out light of specific wavelength ranges, allowing the desired wavelengths to pass through. For example, it can be a component for filtering ultraviolet or far-infrared light. Both surfaces 25a and 25b of the filter unit 25 are flat, and the material is glass.

The protective glass 26 is positioned between the filter unit 25 and the image plane 201 to protect the image plane 201. Both surfaces 26a and 26b of the protective glass 26 are flat, and the material is glass.

The electronic image sensor 202 can be a CCD image sensor or CMOS image sensor.

The detailed optical data and aspherical coefficients of the lens surfaces for the optical imaging lens 20 in the second embodiment are listed in Table 3 and Table 4, respectively. In the second embodiment, the aspherical surface equation is expressed in the same form as in the first embodiment.

TABLE 3
Second Embodiment
TTL = 11 mm, EFL = 3.49 mm, FNO = 2.2, HFOV = 32°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 21a | Spherical | 6.207 | 2.024 | 1.729 | 54.7 | −5.1 |
| | | Surface | | | | | |
| | 21b | Spherical | 2.000 | 1.251 | | | |
| | | Surface | | | | | |
| 2nd lens | 22a | Aspherical | −5.253 | 1.325 | 1.537 | 56.0 | 4.0 |
| | | Surface | | | | | |
| | 22b | Aspherical | −2.120 | 0.515 | | | |
| | | Surface | | | | | |
| Aperture | ST | Flat | Infinity | 0.097 | | | |
| Stop | | Surface | | | | | |
| 3rd lens | 23a | Aspherical | 2.787 | 1.964 | 1.619 | 63.9 | 6.1 |
| | | Surface | | | | | |
| | 23b | Aspherical | −1926.062 | 1.121 | | | |
| | | Surface | | | | | |
| 4th lens | 24a | Aspherical | −9.183 | 1.203 | 1.661 | 20.4 | −12.6 |
| | | Surface | | | | | |
| | 24b | Aspherical | 54.302 | 0.096 | | | |
| | | Surface | | | | | |
| Filter | IR | Flat | Infinity | 0.210 | 1.517 | 64.2 | inf |
| Unit | object- | Surface | | | | | |
| | side | | | | | | |
| | surface | | | | | | |
| | IR | Flat | Infinity | 0.746 | | | |
| | image- | Surface | | | | | |
| | side | | | | | | |
| | surface | | | | | | |
| CG | CG | Flat | Infinity | 0.400 | 1.517 | 64.2 | inf |
| | object- | Surface | | | | | |
| | side | | | | | | |
| | surface | | | | | | |
| | CG | Flat | Infinity | 0.050 | | | |
| | image- | Surface | | | | | |
| | side | | | | | | |
| | surface | | | | | | |
| Image | | Flat | Infinity | 0.000 | | | |
| Plane | | Surface | | | | | |

Reference Wavelength: 940 nm

TABLE 4
Second Embodiment_Aspherical Surface Coefficient

| | 22a | 22b | 23a | 23b | 24a | 24b |
|---|---|---|---|---|---|---|
| K | −3.94E+00 | −1.91E+00 | −1.86E+00 | 1.14E+06 | −4.31E+01 | 8.40E+02 |
| A4 | −3.72E−02 | −2.18E−02 | 2.23E−02 | −1.15E−02 | −1.12E−01 | −5.52E−02 |
| A6 | −2.68E−03 | −1.61E−03 | 1.82E−03 | 4.65E−04 | −1.73E−02 | 4.00E−03 |
| A8 | 2.61E−04 | −7.48E−04 | −2.12E−03 | 1.79E−03 | −3.06E−03 | −1.28E−03 |
| A10 | −1.52E−03 | 4.82E−05 | 6.38E−04 | −9.96E−04 | −9.94E−03 | 2.84E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

TABLE 5
Second Embodiment

| No. | Condition | value |
|---|---|---|
| 1 | f3/EFL | 1.740 |
| 2 | (f1 + f2)/EFL | −0.335 |
| 3 | (f3 + f4)/EFL | −1.865 |
| 4 | R3/R4 | 2.478 |
| 5 | f2/EFL | 1.138 |
| 6 | R4/f2 | −0.534 |
| 7 | (R3-R4)/f2 | −0.789 |
| 8 | (CT1-CT2)/AT12 | 0.558 |
| 9 | (CT2-CT3)/AT23 | −1.043 |
| 10 | (CT3-CT4)/AT34 | 0.387 |
| 11 | TTL/CT1 | 5.436 |
| 12 | f2/ImgH | 1.806 |
| 13 | f3/ImgH | 2.761 |
| 14 | ImgH/EFL | 0.630 |
| 15 | (Vd3-Vd4)/Vd1 | 0.795 |

FIG. 2B shows, from left to right, the astigmatism/field curvature curves, f-tan θ distortion curves, f-θ distortion curves and the longitudinal spherical aberration curves of the optical imaging lens 20. It can be seen from the astigmatism/field curvature curve (wavelength 940 nm), the aberration in the sagittal direction (S) varies between −0.02 and −0.01 mm across the entire field of view, while the aberration in the tangential direction (T) varies between −0.04 and 0.00 mm. From the f-tan θ distortion curve (wavelength 940 nm), it is evident that the absolute value of the f-tan θ distortion rate of the optical imaging lens 20 is less than 3%. From the f-θ distortion curve (wavelength 940 nm), it can be observed that the absolute value of the f-θ distortion rate of the optical imaging lens 20 is less than 3%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.02 to 0.01 mm. As shown in FIG. 2B, the optical imaging lens 20 of this embodiment has effectively corrected various aberrations, meeting the imaging quality requirements of the optical system.

### Third Embodiment

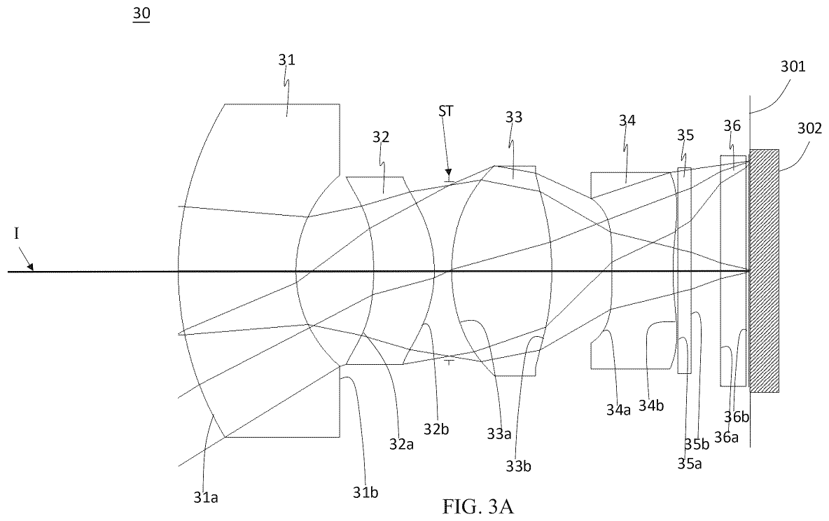

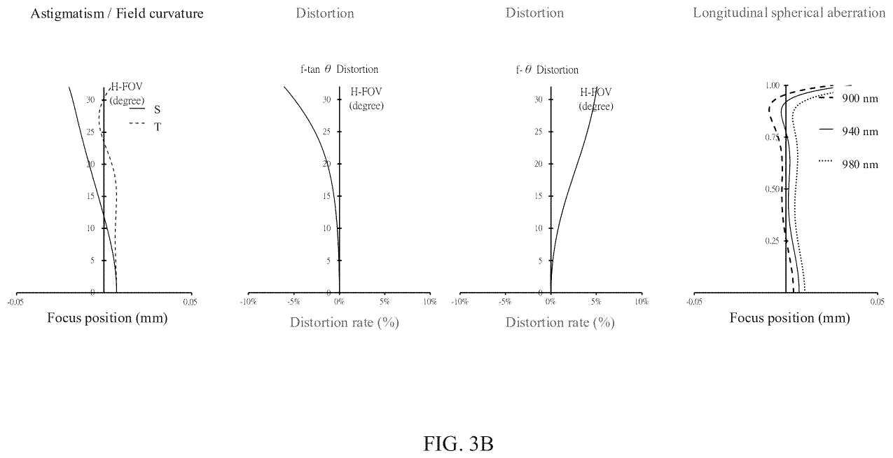

Referring to FIGS. 3A and 3B, FIG. 32A is a schematic view of an optical imaging lens of a third embodiment according to the present invention. FIG. 3B, from left to right, shows the astigmatism/field curvature curves, f-tan θ distortion curves, f-θ distortion curves and the longitudinal spherical aberration curves of the optical imaging lens according to the third embodiment.

As shown in FIG. 3A, the optical imaging lens 30 of the third embodiment includes, in order from an object side to an image side, a first lens 31, a second lens 32, an aperture stop ST, a third lens 33 and a fourth lens 34. The optical imaging lens 30 may further include a filter unit 35, a protective glass 36 and an image plane 301. An electronic image sensor 302 can be disposed on the image plane 301 of the optical imaging lens 30 to form an imaging device (not labeled).

The first lens 31 has negative refractive power. Its object-side surface 31a is convex while its image-side surface 31b is concave. Both of the object-side surface 31a and the image-side surface 31b are spherical. The material of the first lens 31 includes glass, but is not limited thereto.

The second lens 32 has positive refractive power. Its object-side surface 32a is concave while its image-side surface 32b is convex. Both of the object-side surface 32a and the image-side surface 32b are aspheric. The material of second lens 32 includes plastic, but is not limited thereto.

The third lens 33 has positive refractive power. Its object-side surface 33a is convex and its image-side surface 33b is convex. Both of the object-side surface 33a and the image-side surface 33b are aspheric. The material of third lens 33 includes glass, but is not limited thereto.

The fourth lens 34 has negative refractive power. Its object-side surface 34a is concave, and its image-side surface 34b is concave. Both of the object-side surface 24a and the image-side surface 24b are aspheric. The material of the fourth lens 24 includes plastic, but is not limited thereto.

The filter unit 35 is positioned between the fourth lens 34 and the image plane 301 to filter out light of specific wavelength ranges, allowing the desired wavelengths to pass through. For example, it can be a component for filtering ultraviolet or far-infrared light. Both surfaces 35a and 35b of the filter unit 35 are flat, and the material is glass.

The protective glass 36 is positioned between the filter unit 35 and the image plane 301 to protect the image plane 301. Both surfaces 36a and 36b of the protective glass 36 are flat, and the material is glass.

The electronic image sensor 302 can be a CCD image sensor or CMOS image sensor.

The detailed optical data and aspherical coefficients of the lens surfaces for the optical imaging lens 30 in the third embodiment are listed in Table 6 and Table 7, respectively. In the third embodiment, the aspherical surface equation is expressed in the same form as in the first embodiment.

TABLE 6
Third Embodiment
TTL = 9.04 mm, EFL = 2.95 mm, FNO = 1.48, HFOV = 32°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 31a | Spherical | 5.079 | 1.862 | 1.729 | 54.7 | −6.2 |
| | | Surface | | | | | |
| | 31b | Spherical | 1.999 | 1.231 | | | |
| | | Surface | | | | | |
| 2nd lens | 32a | Aspherical | −4.161 | 0.961 | 1.537 | 56.0 | 6.7 |
| | | Surface | | | | | |
| | 32b | Aspherical | −2.058 | 0.233 | | | |
| | | Surface | | | | | |
| Aperture | ST | Flat | Infinity | 0.042 | | | |
| Stop | | Surface | | | | | |
| 3rd lens | 33a | Aspherical | 2.897 | 1.584 | 1.619 | 63.9 | 3.2 |
| | | Surface | | | | | |
| | 33b | Aspherical | −4.684 | 0.954 | | | |
| | | Surface | | | | | |
| 4th lens | 34a | Aspherical | −66.965 | 0.965 | 1.661 | 20.4 | −5.6 |
| | | Surface | | | | | |
| | 34b | Aspherical | 3.746 | 0.073 | | | |
| | | Surface | | | | | |
| Filter | IR object- | Flat | Infinity | 0.210 | 1.517 | 64.2 | inf |
| Unit | side | Surface | | | | | |
| | surface | | | | | | |
| | IR image- | Flat | Infinity | 0.473 | | | |
| | side | Surface | | | | | |
| | surface | | | | | | |
| CG | CG | Flat | Infinity | 0.400 | 1.517 | 64.2 | inf |
| | object-side | Surface | | | | | |
| | surface | | | | | | |
| | CG | Flat | Infinity | 0.050 | | | |
| | image-side | Surface | | | | | |
| | surface | | | | | | |
| Image | | Flat | Infinity | 0.000 | | | |
| Plane | | Surface | | | | | |

Reference Wavelength: 940 nm

TABLE 7
Third Embodiment_Aspherical Surface Coefficient

| | 32a | 32b | 33a | 33b | 34a | 34b |
|---|---|---|---|---|---|---|
| K | 5.90E+00 | −1.44E+00 | −1.01E+00 | 4.36E+00 | 0.00E+00 | 3.44E+00 |
| A4 | −5.60E−02 | −2.21E−02 | 2.50E−02 | −1.54E−02 | −1.39E−01 | −9.02E−02 |
| A6 | 4.47E−04 | 5.13E−03 | 1.50E−03 | 1.02E−02 | −2.54E−02 | 6.99E−03 |
| A8 | 8.93E−03 | −5.67E−05 | −1.01E−03 | 3.17E−04 | 1.30E−02 | −6.34E−04 |
| A10 | 1.96E−04 | 1.22E−03 | 2.17E−04 | −1.11E−04 | −1.69E−02 | −3.67E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the third embodiment, the values of various conditions for the optical imaging lens 30 are listed in Table 8. From Table 8, it can be seen that the optical imaging lens 30 of the third embodiment satisfies the requirements of conditions (1) to (15).

TABLE 8
Third Embodiment

| No. | Condition | value |
|---|---|---|
| 1 | f3/EFL | 1.087 |
| 2 | (f1 + f2)/EFL | 0.167 |
| 3 | (f3 + f4)/EFL | −0.797 |
| 4 | R3/R4 | 2.022 |
| 5 | f2/EFL | 2.256 |
| 6 | R4/f2 | −0.309 |
| 7 | (R3-R4)/f2 | −0.316 |
| 8 | (CT1-CT2)/AT12 | 0.733 |
| 9 | (CT2-CT3)/AT23 | −2.259 |
| 10 | (CT3-CT4)/AT34 | 0.391 |
| 11 | TTL/CT1 | 4.855 |
| 12 | f2/ImgH | 3.170 |
| 13 | f3/ImgH | 1.527 |
| 14 | ImgH/EFL | 0.712 |
| 15 | (Vd3-Vd4)/Vd1 | 0.795 |

FIG. 3B shows, from left to right, the astigmatism/field curvature curves, f-tan θ distortion curves, f-θ distortion curves and the longitudinal spherical aberration curves of the optical imaging lens 30. It can be seen from the astigmatism/field curvature curve (wavelength 940 nm), the aberration in the sagittal direction (S) varies between −0.02 and 0.01 mm across the entire field of view, while the aberration in the tangential direction (T) varies between 0.00 and 0.01 mm. From the f-tan θ distortion curve (wavelength 940 nm), it is evident that the absolute value of the f-tan θ distortion rate of the optical imaging lens 30 is less than 6%. From the f-θ distortion curve (wavelength 940 nm), it can be observed that the absolute value of the f-θ distortion rate of the optical imaging lens 30 is less than 5%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.01 to 0.05 mm. As shown in FIG. 3B, the optical imaging lens 30 of this embodiment has effectively corrected various aberrations, meeting the imaging quality requirements of the optical system.

### Fourth Embodiment

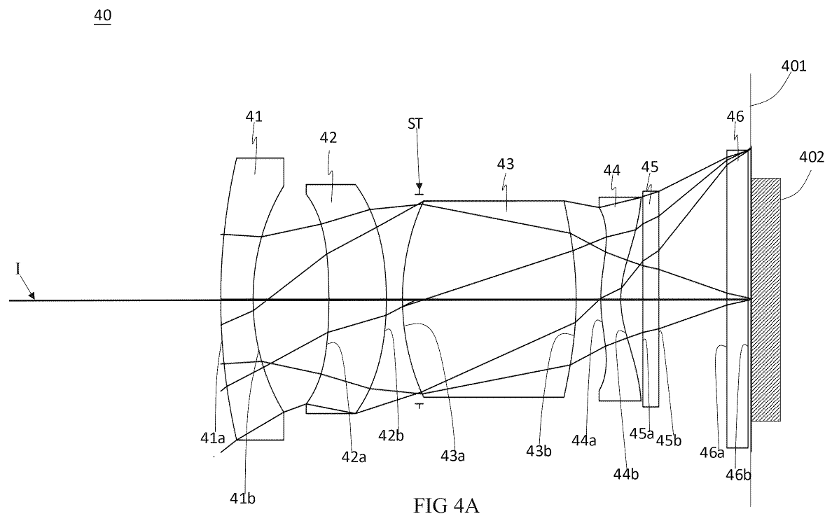

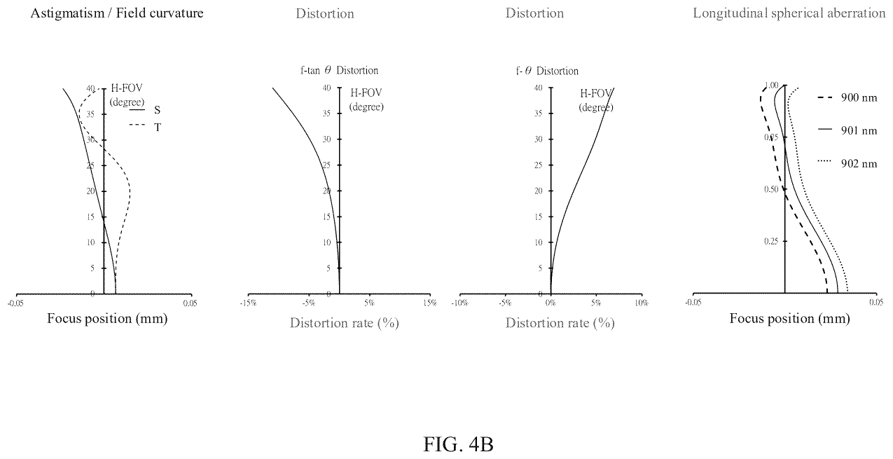

Referring to FIGS. 4A and 4B, FIG. 4A is a schematic view of an optical imaging lens of a fourth embodiment according to the present invention. FIG. 4B, from left to right, shows the astigmatism/field curvature curves, f-tan θ distortion curves, f-θ distortion curves and the longitudinal spherical aberration curves of the optical imaging lens according to the fourth embodiment.

As shown in FIG. 4A, the optical imaging lens 40 of the fourth embodiment includes, in order from an object side to an image side, a first lens 41, a second lens 42, an aperture stop ST, a third lens 43 and a fourth lens 44. The optical imaging lens 40 may further include a filter unit 45, a protective glass 46 and an image plane 401. An electronic image sensor 402 can be disposed on the image plane 401 of the optical imaging lens 40 to form an imaging device (not labeled).

The first lens 41 has negative refractive power. Its object-side surface 41a is convex while its image-side surface 41b is concave. Both of the object-side surface 41a and the image-side surface 41b are spherical. The material of the first lens 41 includes glass, but is not limited thereto.

The second lens 42 has positive refractive power. Its object-side surface 42a is concave while its image-side surface 42b is convex. Both of the object-side surface 42a and the image-side surface 42b are aspheric. The material of second lens 42 includes plastic, but is not limited thereto.

The third lens 43 has positive refractive power. Its object-side surface 43a is convex and its image-side surface 43b is convex. Both of the object-side surface 43a and the image-side surface 43b are aspheric. The material of third lens 43 includes glass, but is not limited thereto.

The fourth lens 44 has negative refractive power. Its object-side surface 44a is convex while its image-side surface 44b is concave. Both of the object-side surface 44a and the image-side surface 44b are aspheric. The material of the fourth lens 44 includes plastic, but is not limited thereto.

The filter unit 45 is positioned between the fourth lens 44 and the image plane 401 to filter out light of specific wavelength ranges, allowing the desired wavelengths to pass through. For example, it can be a component for filtering ultraviolet or far-infrared light. Both surfaces 45a and 45b of the filter unit 45 are flat, and the material is glass.

The protective glass 46 is positioned between the filter unit 45 and the image plane 401 to protect the image plane 401. Both surfaces 46a and 46b of the protective glass 46 are flat, and the material is glass.

The electronic image sensor 402 can be a CCD image sensor or CMOS image sensor.

The detailed optical data and aspherical coefficients of the lens surfaces for the optical imaging lens 40 in the fourth embodiment are listed in Table 9 and Table 10, respectively. In the fourth embodiment, the aspherical surface equation is expressed in the same form as in the first embodiment.

TABLE 9
Fourth Embodiment
TTL = 10 mm, EFL = 3.63 mm, FNO = 1.85, HFOV = 32°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | | | | |
| | | Surface | | | | | |
| 1st lens | 41a | Spherical | 7.747 | 0.607 | 1.729 | 54.7 | −6.5 |
| | | Surface | | | | | |
| | 41b | Spherical | 2.817 | 1.426 | | | |
| | | Surface | | | | | |
| 2nd lens | 42a | Aspherical | −7.040 | 1.081 | 1.537 | 56.0 | 16.1 |
| | | Surface | | | | | |
| | 42b | Aspherical | −4.056 | 0.579 | | | |
| | | Surface | | | | | |
| Aperture | ST | Flat | Infinity | −0.277 | | | |
| Stop | | Surface | | | | | |
| 3rd lens | 43a | Aspherical | 2.851 | 3.266 | 1.625 | 58.2 | 3.4 |
| | | Surface | | | | | |
| | 43b | Aspherical | −4.513 | 0.464 | | | |
| | | Surface | | | | | |
| 4th lens | 44a | Aspherical | 1.954 | 0.376 | 1.661 | 20.4 | −6.2 |
| | | Surface | | | | | |
| | 44b | Aspherical | 1.213 | 0.415 | | | |
| | | Surface | | | | | |
| Filter | IR | Flat | Infinity | 0.300 | 1.517 | 64.2 | inf |
| Unit | object- | Surface | | | | | |
| | side | | | | | | |
| | surface | | | | | | |
| | IR | Flat | Infinity | 1.279 | | | |
| | image- | Surface | | | | | |
| | side | | | | | | |
| | surface | | | | | | |
| CG | CG | Flat | Infinity | 0.400 | 1.517 | 64.2 | inf |
| | object- | Surface | | | | | |
| | side | | | | | | |
| | surface | | | | | | |
| | CG | Flat | Infinity | 0.062 | | | |
| | image- | Surface | | | | | |
| | side | | | | | | |
| | surface | | | | | | |
| Image | | Flat | Infinity | 0.000 | | | |
| Plane | | Surface | | | | | |

Reference Wavelength: 940 nm

TABLE 10
Fourth Embodiment_Aspherical Surface Coefficient

| | 42a | 42b | 43a | 43b | 44a | 44b |
|---|---|---|---|---|---|---|
| K | 5.49E+00 | 1.54E+00 | −3.67E+00 | 2.27E−01 | −4.24E+00 | −1.26E+00 |
| A4 | −2.53E−02 | −2.66E−02 | 1.03E−02 | −5.50E−03 | −1.25E−01 | −1.81E−01 |
| A6 | −8.36E−03 | 4.75E−03 | 2.10E−03 | 8.11E−03 | 2.39E−03 | 6.19E−02 |
| A8 | 3.04E−03 | −4.94E−04 | −1.52E−04 | −1.86E−03 | 1.00E−02 | −1.29E−02 |
| A10 | −6.07E−04 | −2.36E−05 | −5.12E−05 | 1.81E−04 | −3.81E−03 | 1.16E−03 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the fourth embodiment, the values of various conditions for the optical imaging lens 40 are listed in Table 9. From Table 9, it can be seen that the optical imaging lens 40 of the third embodiment satisfies the requirements of conditions (1) to (15).

TABLE 11
Fourth Embodiment

| No. | Condition | value |
|---|---|---|
| 1 | f3/EFL | 0.949 |
| 2 | (f1 + f2)/EFL | 2.638 |
| 3 | (f3 + f4)/EFL | −0.770 |
| 4 | R3/R4 | 1.736 |
| 5 | f2/EFL | 4.434 |
| 6 | R4/f2 | −0.252 |
| 7 | (R3-R4)/f2 | −0.185 |
| 8 | (CT1-CT2)/AT12 | −0.332 |
| 9 | (CT2-CT3)/AT23 | −7.224 |
| 10 | (CT3-CT4)/AT34 | 0.885 |
| 11 | TTL/CT1 | 16.462 |
| 12 | f2/ImgH | 6.706 |
| 13 | f3/ImgH | 1.435 |
| 14 | ImgH/EFL | 0.661 |
| 15 | (Vd3-Vd4)/Vd1 | 0.692 |

FIG. 4B shows, from left to right, the astigmatism/field curvature curves, f-tan θ distortion curves, f-θ distortion curves and the longitudinal spherical aberration curves of the optical imaging lens 40. It can be seen from the astigmatism/field curvature curve (wavelength 940 nm), the aberration in the sagittal direction (S) varies between −0.02 and 0.01 mm across the entire field of view, while the aberration in the tangential direction (T) remains within +0.01. From the f-tan θ distortion curve (wavelength 940 nm), it is evident that the absolute value of the f-tan θ distortion rate of the optical imaging lens 40 is less than 11%. From the f-θ distortion curve (wavelength 940 nm), it can be observed that the absolute value of the f-θ distortion rate of the optical imaging lens 40 is less than 7%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.01 to 0.03 mm. As shown in FIG. 4B, the optical imaging lens 40 of this embodiment has effectively corrected various aberrations, meeting the imaging quality requirements of the optical system.

### Fifth Embodiment

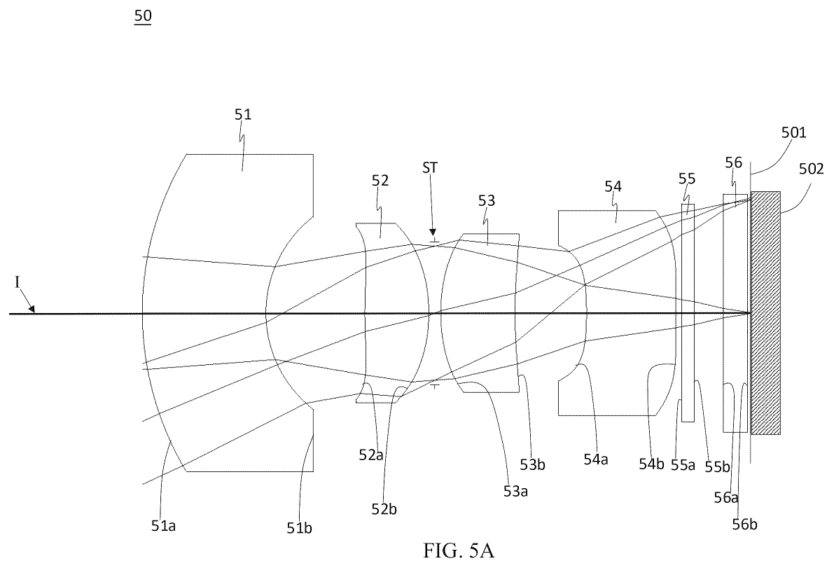

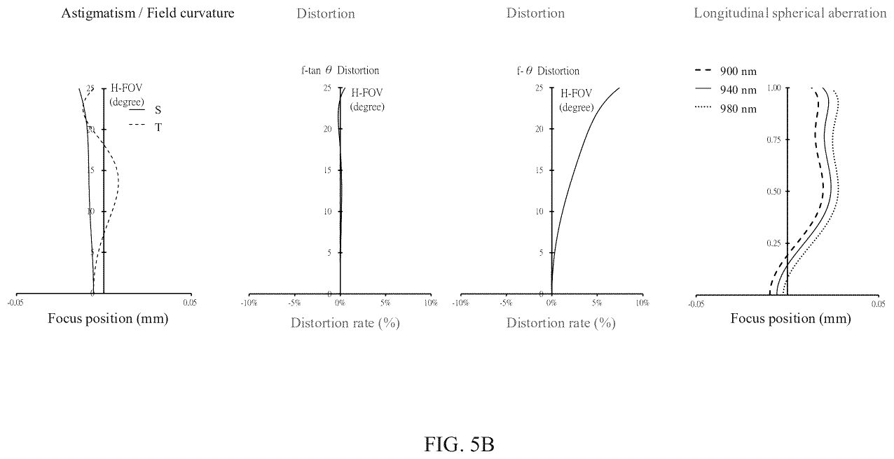

Referring to FIGS. 5A and 5B, FIG. 5A is a schematic view of an optical imaging lens of a fifth embodiment according to the present invention. FIG. 5B, from left to right, shows the astigmatism/field curvature curves, f-tan θ distortion curves, f-θ distortion curves and the longitudinal spherical aberration curves of the optical imaging lens according to the fifth embodiment.

As shown in FIG. 5A, the optical imaging lens 50 of the fifth embodiment includes, in order from an object side to an image side, a first lens 51, a second lens 52, an aperture stop ST, a third lens 53 and a fourth lens 54. The optical imaging lens 50 may further include a filter unit 45, a protective glass 46 and an image plane 501. An electronic image sensor 502 can be disposed on the image plane 501 of the optical imaging lens 50 to form an imaging device (not labeled).

The first lens 51 has negative refractive power. Its object-side surface 51a is convex while its image-side surface 51b is concave. Both of the object-side surface 51a and the image-side surface 51b are spherical. The material of the first lens 51 includes glass, but is not limited thereto.

The second lens 52 has positive refractive power. Its object-side surface 52a is concave while its image-side surface 52b is convex. Both of the object-side surface 52a and the image-side surface 52b are aspheric. The material of second lens 52 includes plastic, but is not limited thereto.

The third lens 53 has positive refractive power. Its object-side surface 53a is convex and its image-side surface 53b is concave. Both of the object-side surface 53a and the image-side surface 53b are aspheric. The material of third lens 53 includes glass, but is not limited thereto.

The fourth lens 54 has negative refractive power. Its object-side surface 54a is concave while its image-side surface 54b is convex. Both of the object-side surface 54a and the image-side surface 54b are aspheric. The material of the fourth lens 54 includes plastic, but is not limited thereto.

The filter unit 55 is positioned between the fourth lens 54 and the image plane 501 to filter out light of specific wavelength ranges, allowing the desired wavelengths to pass through. For example, it can be a component for filtering ultraviolet or far-infrared light. Both surfaces 55a and 55b of the filter unit 55 are flat, and the material is glass.

The protective glass 56 is positioned between the filter unit 55 and the image plane 501 to protect the image plane 501. Both surfaces 56a and 56b of the protective glass 56 are flat, and the material is glass.

The electronic image sensor 502 can be a CCD image sensor or CMOS image sensor.

The detailed optical data and aspherical coefficients of the lens surfaces for the optical imaging lens 50 in the fifth embodiment are listed in Table 12 and Table 13, respectively. In the fifth embodiment, the aspherical surface equation is expressed in the same form as in the first embodiment.

TABLE 12
Fifth Embodiment
TTL = 9.98 mm, EFL = 4.006 mm, FNO = 2.2, HFOV = 25°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 51a | Spherical | 5.060 | 2.027 | 1.729 | 54.7 | −6.4 |
| | | Surface | | | | | |
| | 51b | Spherical | 2.000 | 1.626 | | | |
| | | Surface | | | | | |
| 2nd lens | 52a | Aspherical | 8.290 | 1.049 | 1.537 | 56.0 | 4.0 |
| | | Surface | | | | | |
| | 52b | Aspherical | −2.683 | 0.097 | | | |
| | | Surface | | | | | |
| Aperture | ST | Flat | Infinity | 0.099 | | | |
| Stop | | Surface | | | | | |
| 3rd lens | 53a | Aspherical | 2.933 | 1.219 | 1.619 | 63.9 | 6.9 |
| | | Surface | | | | | |
| | 53b | Aspherical | 8.239 | 1.174 | | | |
| | | Surface | | | | | |
| 4th lens | 54a | Aspherical | −5.989 | 1.464 | 1.661 | 20.4 | −7.0 |
| | | Surface | | | | | |
| | 54b | Aspherical | 19.270 | 0.093 | | | |
| | | Surface | | | | | |
| Filter | IR object- | Flat | Infinity | 0.210 | 1.517 | 64.2 | inf |
| Unit | side | Surface | | | | | |
| | surface | | | | | | |
| | IR image- | Flat | Infinity | 0.473 | | | |
| | side | Surface | | | | | |
| | surface | | | | | | |
| CG | CG object- | Flat | Infinity | 0.400 | 1.517 | 64.2 | inf |
| | side | Surface | | | | | |
| | surface | | | | | | |
| | CG image- | Flat | Infinity | 0.050 | | | |
| | side | Surface | | | | | |
| | surface | | | | | | |
| Image | | Flat | Infinity | 0.000 | | | |
| Plane | | Surface | | | | | |

Reference Wavelength: 940 nm

TABLE 13
Fifth Embodiment_Aspherical Surface Coefficient

| | 52a | 52b | 53a | 53b | 54a | 54b |
|---|---|---|---|---|---|---|
| K | −5.35E+00 | 5.16E−01 | 0.00E+00 | 0.00E+00 | 4.70E+00 | −2.69E+01 |
| A4 | −4.33E−02 | −2.11E−02 | 4.11E−03 | −1.35E−02 | −1.24E−01 | −5.80E−02 |
| A6 | −7.67E−03 | 1.17E−02 | 2.65E−02 | 3.17E−03 | −3.36E−02 | 4.69E−03 |
| A8 | 3.27E−03 | −7.66E−03 | −1.59E−02 | −2.51E−04 | −7.98E−04 | −2.34E−03 |
| A10 | −2.43E−03 | 1.19E−03 | 4.21E−03 | −7.88E−04 | −3.51E−02 | 5.91E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the fifth embodiment, the values of various conditions for the optical imaging lens 50 are listed in Table 14. From Table 14, it can be seen that the optical imaging lens 50 of the third embodiment satisfies the requirements of conditions (1) to (15).

TABLE 14
Fifth Embodiment

| No. | Condition | value |
|---|---|---|
| 1 | f3/EFL | 1.726 |
| 2 | (f1 + f2)/EFL | −0.604 |
| 3 | (f3 + f4)/EFL | −0.030 |
| 4 | R3/R4 | −3.089 |
| 5 | f2/EFL | 0.991 |
| 6 | R4/f2 | −0.676 |
| 7 | (R3-R4)/f2 | 2.765 |
| 8 | (CT1-CT2)/AT12 | 0.602 |
| 9 | (CT2-CT3)/AT23 | −0.872 |
| 10 | (CT3-CT4)/AT34 | −0.201 |
| 11 | TTL/CT1 | 4.922 |
| 12 | f2/ImgH | 2.133 |
| 13 | f3/ImgH | 3.717 |
| 14 | ImgH/EFL | 0.464 |
| 15 | (Vd3-Vd4)/Vd1 | 0.795 |

FIG. 5B shows, from left to right, the astigmatism/field curvature curves, f-tan θ distortion curves, f-θ distortion curves and the longitudinal spherical aberration curves of the optical imaging lens 50. It can be seen from the astigmatism/field curvature curve (wavelength 940 nm), the aberration in the sagittal direction (S) remains within −0.01 mm across the entire field of view, while the aberration in the tangential direction (T) remains within +0.01 mm. From the f-tan θ distortion curve (wavelength 940 nm), it is evident that the absolute value of the f-tan θ distortion rate of the optical imaging lens 50 is less than 1%. From the f-θ distortion curve (wavelength 940 nm), it can be observed that the absolute value of the f-θ distortion rate of the optical imaging lens 50 is less than 7%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.01 to 0.03 mm. As shown in FIG. 5B, the optical imaging lens 50 of this embodiment has effectively corrected various aberrations, meeting the imaging quality requirements of the optical system.

### Sixth Embodiment

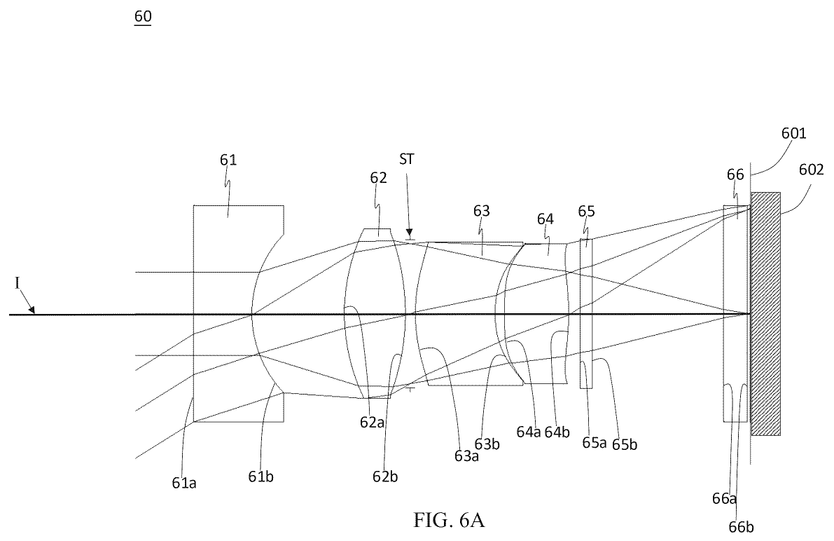

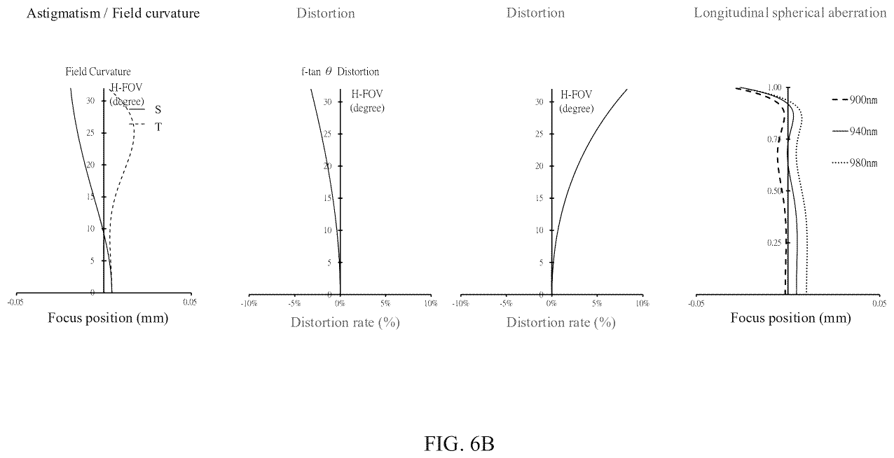

Referring to FIGS. 6A and 6B, FIG. 6A is a schematic view of an optical imaging lens of a sixth embodiment according to the present invention. FIG. 6B, from left to right, shows the astigmatism/field curvature curves, f-tan θ distortion curves, f-θ distortion curves and the longitudinal spherical aberration curves of the optical imaging lens according to the fourth embodiment.

As shown in FIG. 6A, the optical imaging lens 60 of the sixth embodiment includes, in order from an object side to an image side, a first lens 61, a second lens 62, an aperture stop ST, a third lens 63 and a fourth lens 64. The optical imaging lens 60 may further include a filter unit 65, a protective glass 66 and an image plane 601. An electronic image sensor 602 can be disposed on the image plane 601 of the optical imaging lens 60 to form an imaging device (not labeled).

The first lens 61 has negative refractive power. Its object-side surface 61a is flat while its image-side surface 61b is concave. Both of the object-side surface 61a and the image-side surface 61b are spherical. The material of the first lens 61 includes glass, but is not limited thereto.

The second lens 62 has positive refractive power. Its object-side surface 62a is convex, and its image-side surface 62b is convex. Both of the object-side surface 62a and the image-side surface 62b are spherical. The material of second lens 62 includes glass, but is not limited thereto.

The third lens 63 has negative refractive power. Its object-side surface 63a is convex while its image-side surface 63b is concave. Both of the object-side surface 63a and the image-side surface 63b are aspheric. The material of third lens 63 includes plastic, but is not limited thereto.

The fourth lens 64 has positive refractive power. Its object-side surface 64a is convex, and its image-side surface 64b is convex. Both of the object-side surface 64a and the image-side surface 64b are aspheric. The material of the fourth lens 64 includes plastic, but is not limited thereto.

The filter unit 65 is positioned between the fourth lens 64 and the image plane 601 to filter out light of specific wavelength ranges, allowing the desired wavelengths to pass through. For example, it can be a component for filtering ultraviolet or far-infrared light. Both surfaces 65a and 65b of the filter unit 65 are flat, and the material is glass.

The protective glass 66 is positioned between the filter unit 65 and the image plane 601 to protect the image plane 601. Both surfaces 66a and 66b of the protective glass 66 are flat, and the material is glass.

The electronic image sensor 602 can be a CCD image sensor or CMOS image sensor.

The detailed optical data and aspherical coefficients of the lens surfaces for the optical imaging lens 60 in the sixth embodiment are listed in Table 15 and Table 16, respectively. In the sixth embodiment, the aspherical surface equation is expressed in the same form as in the first embodiment.

TABLE 15
Sixth Embodiment
TTL = 9.55 mm, EFL = 2.96 mm, FNO = 2, HFOV = 32°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 61a | Spherical | Infinity | 1.000 | 1.729 | 54.7 | −2.8 |
| | | Surface | | | | | |
| | 61b | Spherical | 1.976 | 1.589 | | | |
| | | Surface | | | | | |
| 2nd lens | 62a | Spherical | 3.338 | 1.046 | 1.619 | 63.9 | 3.1 |
| | | Surface | | | | | |
| | 62b | Spherical | −3.936 | 0.084 | | | |
| | | Surface | | | | | |
| Aperture | ST | Flat | Infinity | 0.088 | | | |
| Stop | | Surface | | | | | |
| 3rd lens | 63a | Aspherical | 2.898 | 1.368 | 1.661 | 20.4 | −16.0 |
| | | Surface | | | | | |
| | 63b | Aspherical | 1.842 | 0.160 | | | |
| | | Surface | | | | | |
| 4th lens | 64a | Aspherical | 6.954 | 1.104 | 1.536 | 56.0 | 5.1 |
| | | Surface | | | | | |
| | 64b | Aspherical | −4.201 | 0.200 | | | |
| | | Surface | | | | | |
| Filter | IR object- | Flat | Infinity | 0.210 | 1.517 | 64.2 | inf |
| Unit | side | Surface | | | | | |
| | surface | | | | | | |
| | IR image- | Flat | Infinity | 2.254 | | | |
| | side | Surface | | | | | |
| | surface | | | | | | |
| CG | CG | Flat | Infinity | 0.400 | 1.517 | 64.2 | inf |
| | object-side | Surface | | | | | |
| | surface | | | | | | |
| | CG | Flat | Infinity | 0.050 | | | |
| | image-side | Surface | | | | | |
| | surface | | | | | | |
| Image | | Flat | Infinity | 0.000 | | | |
| Plane | | Surface | | | | | |

Reference Wavelength: 940 nm

TABLE 16
Sixth Embodiment_Aspherical Surface
Coefficient

| | 63a | 63b | 64a | 64b |
|---|---|---|---|---|
| K | −1.17E+00 | −1.16E−02 | 0.00E+00 | −5.16E+00 |
| A4 | −4.53E−03 | 4.36E−02 | 8.91E−02 | 3.24E−02 |
| A6 | −2.50E−03 | 9.72E−02 | 1.41E−01 | 2.89E−02 |
| A8 | −5.77E−03 | −1.19E−01 | −1.21E−01 | −1.40E−02 |
| A10 | 1.80E−03 | 3.22E−02 | 2.74E−02 | 6.79E−03 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |

In the sixth embodiment, the values of various conditions for the optical imaging lens 60 are listed in Table 17. From Table 17, it can be seen that the optical imaging lens 60 of the third embodiment satisfies the requirements of conditions (1) to (15).

TABLE 17
Sixth Embodiment

| No. | Condition | value |
|---|---|---|
| 1 | f3/EFL | −5.408 |
| 2 | (f1 + f2)/EFL | 0.123 |
| 3 | (f3 + f4)/EFL | −3.674 |
| 4 | R3/R4 | −0.848 |
| 5 | f2/EFL | 1.059 |
| 6 | R4/f2 | −1.256 |
| 7 | (R3-R4)/f2 | 2.321 |
| 8 | (CT1-CT2)/AT12 | −0.029 |
| 9 | (CT2-CT3)/AT23 | −1.866 |
| 10 | (CT3-CT4)/AT34 | 0.193 |
| 11 | TTL/CT1 | 9.550 |
| 12 | f2/ImgH | 1.741 |
| 13 | f3/ImgH | −8.893 |
| 14 | ImgH/EFL | 0.608 |
| 15 | (Vd3-Vd4)/Vd1 | −0.651 |

FIG. 6B shows, from left to right, the astigmatism/field curvature curves, f-tan θ distortion curves, f-θ distortion curves and the longitudinal spherical aberration curves of the optical imaging lens 60. It can be seen from the astigmatism/field curvature curve (wavelength 940 nm), the aberration in the sagittal direction (S) varies between −0.01 and 0.00 mm across the entire field of view, while the aberration in the tangential direction (T) varies between 0.00 and 0.02 mm. From the f-tan θ distortion curve (wavelength 940 nm), it is evident that the absolute value of the f-tan θ distortion rate of the optical imaging lens 60 is less than 3%. From the f-θ distortion curve (wavelength 940 nm), it can be observed that the absolute value of the f-θ distortion rate of the optical imaging lens 60 is less than 8%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.03 to 0.01 mm. As shown in FIG. 6B, the optical imaging lens 60 of this embodiment has effectively corrected various aberrations, meeting the imaging quality requirements of the optical system.

### Seventh Embodiment

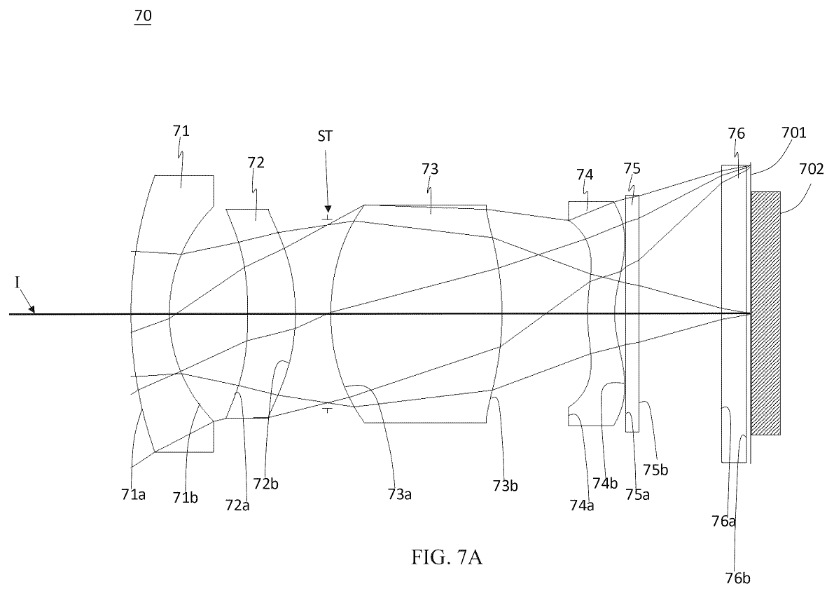

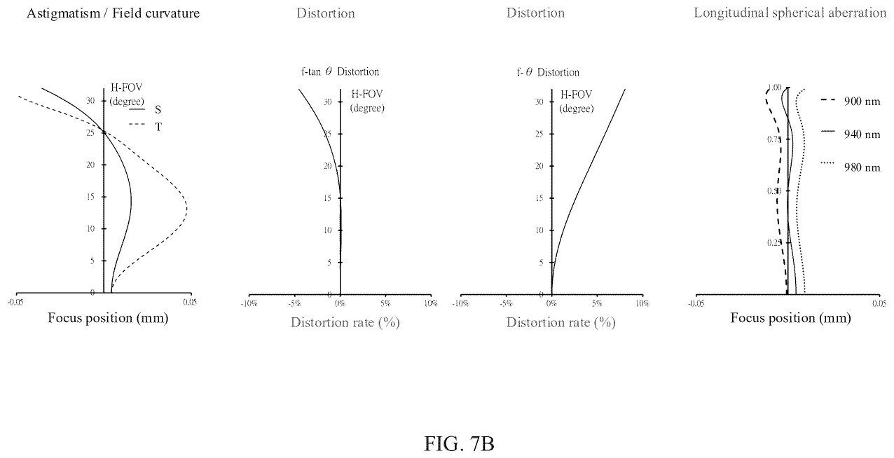

Referring to FIGS. 7A and 7B, FIG. 7A is a schematic view of an optical imaging lens of a seventh embodiment according to the present invention. FIG. 7B, from left to right, shows the astigmatism/field curvature curves, f-tan θ distortion curves, f-θ distortion curves and the longitudinal spherical aberration curves of the optical imaging lens according to the seventh embodiment.

As shown in FIG. 7A, the optical imaging lens 70 of the seventh embodiment includes, in order from an object side to an image side, a first lens 71, a second lens 72, an aperture stop ST, a third lens 73 and a fourth lens 74. The optical imaging lens 70 may further include a filter unit 75, a protective glass 76 and an image plane 701. An electronic image sensor 702 can be disposed on the image plane 701 of the optical imaging lens 70 to form an imaging device (not labeled).

The first lens 71 has negative refractive power. Its object-side surface 71a is convex while its image-side surface 71b is concave. Both of the object-side surface 71a and the image-side surface 71b are spherical. The material of the first lens 71 includes glass, but is not limited thereto.

The second lens 72 has positive refractive power. Its object-side surface 72a is concave while its image-side surface 72b is convex. Both of the object-side surface 72a and the image-side surface 72b are aspheric. The material of second lens 72 includes plastic, but is not limited thereto.

The third lens 73 has positive refractive power. Its object-side surface 73a is convex and its image-side surface 73b is convex. Both of the object-side surface 73a and the image-side surface 73b are aspheric. The material of third lens 73 includes glass, but is not limited thereto.

The fourth lens 74 has negative refractive power. Its object-side surface 74a is convex while its image-side surface 74b is concave. Both of the object-side surface 74a and the image-side surface 74b are aspheric. The material of the fourth lens 74 includes plastic, but is not limited thereto.

The filter unit 75 is positioned between the fourth lens 74 and the image plane 701 to filter out light of specific wavelength ranges, allowing the desired wavelengths to pass through. For example, it can be a component for filtering ultraviolet or far-infrared light. Both surfaces 75a and 75b of the filter unit 75 are flat, and the material is glass.

The protective glass 76 is positioned between the filter unit 75 and the image plane 701 to protect the image plane 701. Both surfaces 76a and 76b of the protective glass 76 are flat, and the material is glass.

The electronic image sensor 702 can be a CCD image sensor or CMOS image sensor.

The detailed optical data and aspherical coefficients of the lens surfaces for the optical imaging lens 70 in the seventh embodiment are listed in Table 18 and Table 19, respectively. In the seventh embodiment, the aspherical surface equation is expressed in the same form as in the first embodiment.

TABLE 18
Seventh Embodiment_Aspherical Surface Coefficient
TTL = 9.988 mm, EFL = 3.776 mm, FNO = 1.9, HFOV = 33°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 71a | Spherical | 6.718 | 0.616 | 1.729 | 54.7 | −5.8 |
| | | Surface | | | | | |
| | 71b | Spherical | 2.464 | 1.267 | | | |
| | | Surface | | | | | |
| 2nd lens | 72a | Aspherical | −6.108 | 0.767 | 1.537 | 56.0 | 12.9 |
| | | Surface | | | | | |
| | 72b | Aspherical | −3.358 | 0.515 | | | |
| | | Surface | | | | | |
| Aperture | ST | Flat | Infinity | 0.057 | | | |
| Stop | | Surface | | | | | |
| 3rd lens | 73a | Aspherical | 3.416 | 2.760 | 1.619 | 63.9 | 3.8 |
| | | Surface | | | | | |
| | 73b | Aspherical | −4.977 | 1.379 | | | |
| | | Surface | | | | | |
| 4th lens | 74a | Aspherical | 2.659 | 0.438 | 1.661 | 20.4 | −9.6 |
| | | Surface | | | | | |
| | 74b | Aspherical | 1.730 | 0.181 | | | |
| | | Surface | | | | | |
| Filter | IR object- | Flat | Infinity | 0.210 | 1.517 | 64.2 | inf |
| Unit | side | Surface | | | | | |
| | surface | | | | | | |
| | IR image- | Flat | Infinity | 2.254 | | | |
| | side | Surface | | | | | |
| | surface | | | | | | |
| CG | CG object- | Flat | Infinity | 0.400 | 1.517 | 64.2 | inf |
| | side | Surface | | | | | |
| | surface | | | | | | |
| | CG image- | Flat | Infinity | 0.050 | | | |
| | side | Surface | | | | | |
| | surface | | | | | | |
| Image | | Flat | Infinity | 0.000 | | | |
| Plane | | Surface | | | | | |

Reference Wavelength: 940 nm

TABLE 19
Seventh Embodiment_Aspherical Surface Coefficient

| | 72a | 72b | 73a | 73b | 74a | 74b |
|---|---|---|---|---|---|---|
| K | −8.13E−01 | −5.56E−01 | −2.51E+00 | 1.09E+00 | −7.90E+00 | −1.32E+00 |
| A4 | −2.62E−02 | −1.41E−02 | 1.09E−02 | −5.64E−03 | −1.21E−01 | −1.66E−01 |
| A6 | −7.52E−04 | 3.21E−03 | 1.34E−03 | 5.04E−03 | 1.41E−03 | 4.71E−02 |
| A8 | 2.55E−03 | 3.98E−04 | −2.40E−04 | −7.50E−04 | 4.03E−03 | −9.65E−03 |
| A10 | −3.00E−04 | 4.22E−05 | 1.87E−05 | 1.74E−04 | −1.82E−03 | 8.91E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the seventh embodiment, the values of various conditions for the optical imaging lens 70 are listed in Table 20. From Table 20, it can be seen that the optical imaging lens 70 of the third embodiment satisfies the requirements of conditions (1) to (15).

TABLE 20
Seventh Embodiment

| No. | Condition | value |
|---|---|---|
| 1 | f3/EFL | 1.011 |
| 2 | (f1 + f2)/EFL | 1.878 |
| 3 | (f3 + f4)/EFL | −1.519 |
| 4 | R3/R4 | 1.819 |
| 5 | f2/EFL | 3.411 |
| 6 | R4/f2 | −0.261 |
| 7 | (R3-R4)/f2 | −0.213 |
| 8 | (CT1-CT2)/AT12 | −0.120 |
| 9 | (CT2-CT3)/AT23 | −3.488 |
| 10 | (CT3-CT4)/AT34 | 1.683 |
| 11 | TTL/CT1 | 16.227 |
| 12 | f2/ImgH | 5.366 |
| 13 | f3/ImgH | 1.590 |
| 14 | ImgH/EFL | 0.636 |
| 15 | (Vd3-Vd4)/Vd1 | 0.795 |

FIG. 7B shows, from left to right, the astigmatism/field curvature curves, f-tan θ distortion curves, f-θ distortion curves and the longitudinal spherical aberration curves of the optical imaging lens 70. It can be seen from the astigmatism/field curvature curve (wavelength 940 nm), the aberration in the sagittal direction (S) varies between −0.04 and 0.02 mm across the entire field of view, while the aberration in the tangential direction (T) remains within +0.05. From the f-tan θ distortion curve (wavelength 940 nm), it is evident that the absolute value of the f-tan θ distortion rate of the optical imaging lens 70 is less than 5%. From the f-θ distortion curve (wavelength 940 nm), it can be observed that the absolute value of the f-θ distortion rate of the optical imaging lens 70 is less than 8%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of +0.01 mm. As shown in FIG. 7B, the optical imaging lens 70 of this embodiment has effectively corrected various aberrations, meeting the imaging quality requirements of the optical system.

### Eighth Embodiment

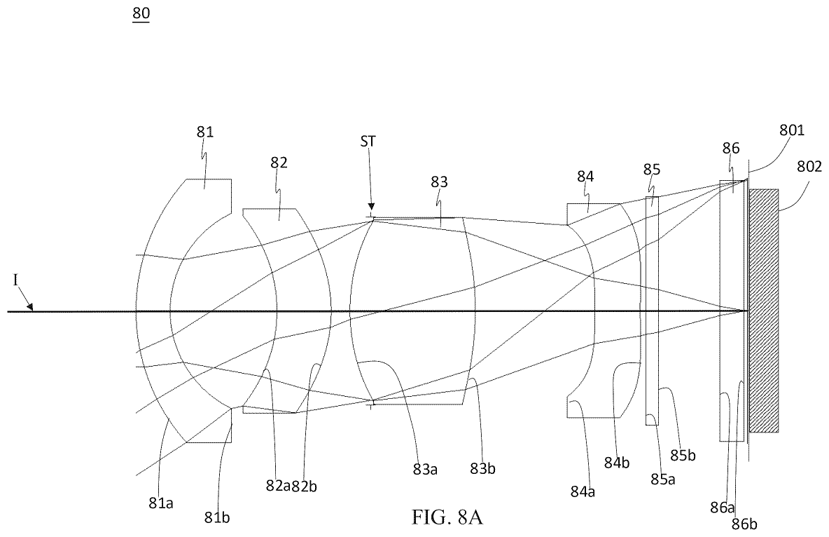

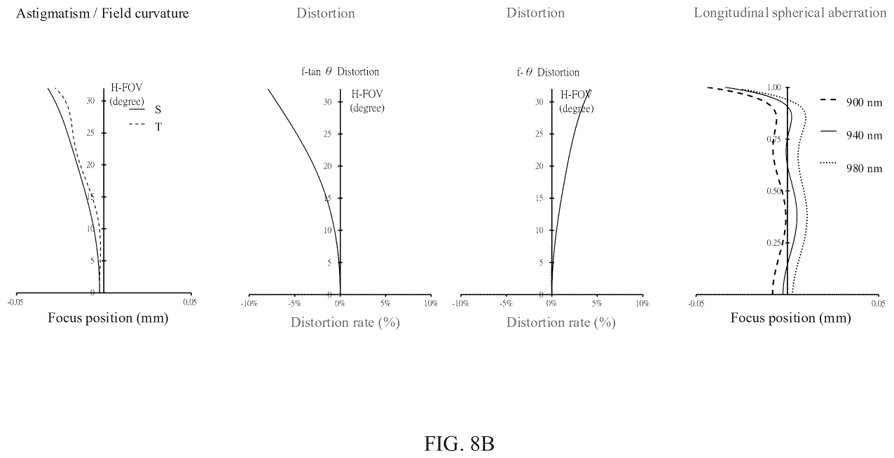

Referring to FIGS. 8A and 8B, FIG. 8A is a schematic view of an optical imaging lens of an eighth embodiment according to the present invention. FIG. 8B, from left to right, shows the astigmatism/field curvature curves, f-tan θ distortion curves, f-θ distortion curves and the longitudinal spherical aberration curves of the optical imaging lens according to the eighth embodiment.

As shown in FIG. 8A, the optical imaging lens 80 of the eighth embodiment includes, in order from an object side to an image side, a first lens 81, a second lens 82, an aperture stop ST, a third lens 83 and a fourth lens 84. The optical imaging lens 80 may further include a filter unit 85, a protective glass 86 and an image plane 801. An electronic image sensor 802 can be disposed on the image plane 801 of the optical imaging lens 80 to form an imaging device (not labeled).

The first lens 81 has negative refractive power. Its object-side surface 81a is convex while its image-side surface 81b is concave. Both of the object-side surface 81a and the image-side surface 81b are spherical. The material of the first lens 81 includes glass, but is not limited thereto.

The second lens 82 has positive refractive power. Its object-side surface 82a is concave while its image-side surface 82b is convex. Both of the object-side surface 82a and the image-side surface 82b are aspheric. The material of second lens 82 includes plastic, but is not limited thereto.

The third lens 83 has positive refractive power. Its object-side surface 83a is convex and its image-side surface 83b is convex. Both of the object-side surface 83a and the image-side surface 83b are aspheric. The material of third lens 83 includes glass, but is not limited thereto.

The fourth lens 84 has negative refractive power. Its object-side surface 84a is concave while its image-side surface 84b is convex. Both of the object-side surface 84a and the image-side surface 84b are aspheric. The material of the fourth lens 84 includes plastic, but is not limited thereto.

The filter unit 85 is positioned between the fourth lens 84 and the image plane 801 to filter out light of specific wavelength ranges, allowing the desired wavelengths to pass through. For example, it can be a component for filtering ultraviolet or far-infrared light. Both surfaces 85a and 85b of the filter unit 85 are flat, and the material is glass.

The protective glass 86 is positioned between the filter unit 85 and the image plane 801 to protect the image plane 801. Both surfaces 86a and 86b of the protective glass 86 are flat, and the material is glass.

The electronic image sensor 802 can be a CCD image sensor or CMOS image sensor.

The detailed optical data and aspherical coefficients of the lens surfaces for the optical imaging lens 80 in the eighth embodiment are listed in Table 21 and Table 22, respectively. In the eighth embodiment, the aspherical surface equation is expressed in the same form as in the first embodiment.

TABLE 21
Eighth Embodiment
TTL = 10 mm, EFL = 3.521 mm, FNO = 1.9, HFOV = 33°

| | | | Curvature | | | | focal |
|---|---|---|---|---|---|---|---|
| | | Surface | Radius | Distance | Refractive | Abbe | length |
| | Surface | type | (mm) | (mm) | Index | Number | (mm) |
| Object | | Flat | Infinity | Infinity | | | |
| | | Surface | | | | | |
| 1st lens | 81a | Spherical | 3.223 | 0.558 | 1.729 | 54.7 | −6.6 |
| | | Surface | | | | | |
| | 81b | Spherical | 1.774 | 1.749 | | | |
| | | Surface | | | | | |
| 2nd lens | 82a | Aspherical | −2.428 | 0.886 | 1.537 | 56.0 | 30.6 |
| | | Surface | | | | | |
| | 82b | Aspherical | −2.378 | 0.654 | | | |
| | | Surface | | | | | |
| Aperture | ST | Flat | Infinity | −0.344 | | | |
| Stop | | Surface | | | | | |
| 3rd lens | 83a | Aspherical | 3.209 | 2.050 | 1.621 | 63.8 | 3.5 |
| | | Surface | | | | | |
| | 83b | Aspherical | −4.991 | 1.961 | | | |
| | | Surface | | | | | |
| 4th lens | 84a | Aspherical | −12.422 | 0.739 | 1.661 | 20.4 | −9.7 |
| | | Surface | | | | | |
| | 84b | Aspherical | 12.557 | 0.091 | | | |
| | | Surface | | | | | |
| Filter | IR object- | Flat | Infinity | 0.210 | 1.517 | 64.2 | inf |
| Unit | side | Surface | | | | | |
| | surface | | | | | | |
| | IR image- | Flat | Infinity | 2.254 | | | |
| | side | Surface | | | | | |
| | surface | | | | | | |
| CG | CG | Flat | Infinity | 0.400 | 1.517 | 64.2 | inf |
| | object-side | Surface | | | | | |
| | surface | | | | | | |
| | CG | Flat | Infinity | 0.050 | | | |
| | image-side | Surface | | | | | |
| | surface | | | | | | |
| Image | | Flat | Infinity | 0.000 | | | |
| Plane | | Surface | | | | | |

Reference Wavelength: 940 nm

TABLE 22
Eighth Embodiment_Aspherical Surface Coefficient

| | 82a | 82b | 83a | 83b | 84a | 84b |
|---|---|---|---|---|---|---|
| K | −6.72E+00 | −4.85E+00 | −3.98E+00 | −1.16E+01 | 2.31E+01 | −9.00E+01 |
| A4 | −6.26E−02 | −3.30E−02 | 2.21E−02 | −1.16E−02 | −8.42E−02 | −6.04E−02 |
| A6 | 1.97E−02 | 7.78E−03 | −2.75E−03 | 4.18E−03 | 1.17E−03 | 7.47E−03 |
| A8 | −5.20E−03 | −1.49E−03 | 1.63E−04 | −4.93E−04 | −3.68E−03 | −1.34E−03 |
| A10 | 6.78E−04 | 1.65E−04 | 9.16E−05 | 1.21E−04 | −1.08E−05 | 1.54E−04 |
| A12 | 0.00E+00 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 | 0.00E+00 |

In the eighth embodiment, the values of various conditions for the optical imaging lens 80 are listed in Table 23. From Table 23, it can be seen that the optical imaging lens 80 of the eighth embodiment satisfies the requirements of conditions (1) to (15).

TABLE 23
Eighth Embodiment

| No. | Condition | value |
|---|---|---|
| 1 | f3/EFL | 1.003 |
| 2 | (f1 + f2)/EFL | 6.835 |
| 3 | (f3 + f4)/EFL | −1.757 |
| 4 | R3/R4 | 1.021 |
| 5 | f2/EFL | 8.699 |
| 6 | R4/f2 | −0.078 |
| 7 | (R3-R4)/f2 | −0.002 |
| 8 | (CT1-CT2)/AT12 | −0.188 |
| 9 | (CT2-CT3)/AT23 | −3.764 |
| 10 | (CT3-CT4)/AT34 | 0.669 |
| 11 | TTL/CT1 | 17.908 |
| 12 | f2/ImgH | 14.181 |
| 13 | f3/ImgH | 1.635 |
| 14 | ImgH/EFL | 0.613 |
| 15 | (Vd3-Vd4)/Vd1 | 0.795 |

FIG. 8B shows, from left to right, the astigmatism/field curvature curves, f-tan θ distortion curves, f-θ distortion curves and the longitudinal spherical aberration curves of the optical imaging lens 80. It can be seen from the astigmatism/field curvature curve (wavelength 940 nm), the aberration in the sagittal direction (S) varies between −0.03 and 0.00 mm across the entire field of view, while the aberration in the tangential direction (T) varies between −0.03 and 0.00 mm. From the f-tan θ distortion curve (wavelength 940 nm), it is evident that the absolute value of the f-tan θ distortion rate of the optical imaging lens 80 is less than 8%. From the f-θ distortion curve (wavelength 940 nm), it can be observed that the absolute value of the f-θ distortion rate of the optical imaging lens 80 is less than 4%. From the longitudinal spherical aberration curve, it can be seen that off-axis light rays at three infrared wavelengths—900 nm, 940 nm, and 980 nm—can all converge near the imaging point. The deviation of the imaging point can be controlled within the range of −0.04 to 0.01 mm. As shown in FIG. 8B, the optical imaging lens 80 of this embodiment has effectively corrected various aberrations, meeting the imaging quality requirements of the optical system.

### Ninth Embodiment

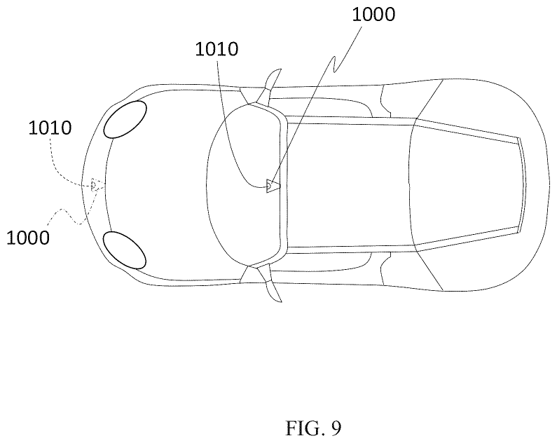

Referring to FIG. 9, an imaging device 1010 comprises an optical imaging lens 10, 20, 30, 40, 50, 60, 70, and 80 described in the first to eighth embodiments, and an image sensor 102 [symbol] 202 [symbol] 302 [symbol] 402 [symbol] 502 [symbol] 602 [symbol] 702 [symbol] 802; wherein the image sensor 102 [symbol] 202 [symbol] 302 [symbol] 402 [symbol] 502 [symbol] 602 [symbol] 702 [symbol] 802 is disposed on an image plane 101 [symbol] 201 [symbol] 301 [symbol] 401 [symbol] 501 [symbol] 601 [symbol] 701 [symbol] 801 of the optical imaging lens 10, 20, 30, 40, 50, 60, 70, 80. The image sensor 102 [symbol] 202 [symbol] 302 [symbol] 402 [symbol] 502 [symbol] 602 [symbol] 702 [symbol] 802 can be Charge-Coupled Devices (CCD) or Complementary Metal Oxide Semiconductor (CMOS) image sensors.

In FIG. 9, an automotive electronic device 1000 according to the ninth embodiment of the present invention includes an imaging device 1010, wherein the automotive electronic device 1000 is used for observing, monitoring, sensing, and/or recording objects or human behaviors and actions inside and outside the vehicle.

### Tenth Embodiment

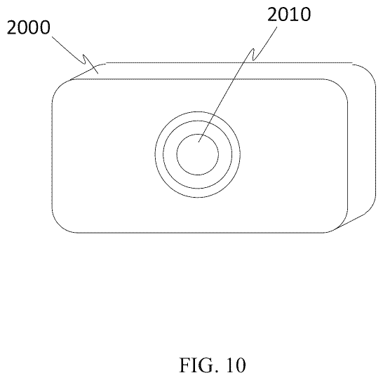

Referring to FIG. 10, an imaging device 2010 comprises an optical imaging lens 10, 20, 30, 40, 50, 60, 70, and 80 described in the first to eighth embodiments, and an image sensor 102 [symbol] 202 [symbol] 302 [symbol] 402 [symbol] 502 [symbol] 602 [symbol] 702 [symbol] 802; wherein the image sensor 102 [symbol] 202 [symbol] 302 [symbol] 402 [symbol] 502 [symbol] 602 [symbol] 702 [symbol] 802 is disposed on an image plane 101 [symbol] 201 [symbol] 301 [symbol] 401 [symbol] 501 [symbol] 601 [symbol] 701 [symbol] 801 of the optical imaging lens 10, 20, 30, 40, 50, 60, 70, 80. The image sensor 102 [symbol] 202 [symbol] 302 [symbol] 402 [symbol] 502 [symbol] 602 [symbol] 702 [symbol] 802 can be Charge-Coupled Devices (CCD) or Complementary Metal Oxide Semiconductor (CMOS) image sensors.

In FIG. 10, the electronic device 2000 according to the tenth embodiment of the present invention includes image device 2010, wherein the electronic device 2000 can be applied to general 3C products and other electronic devices with imaging functions.

The present disclosure has been described above with some embodiments mentioned above. However, the present disclosure is not limited to the embodiments, but various modifications can be made. In addition, various other substitutions and modifications will occur to those skilled in the art. Therefore, all such substitutions and modifications are intended to be embraced within the scope of the present disclosure as defined in the appended claims.

What is claimed is:

1. An optical imaging lens, in order from an object side to an image side, comprising:
a first lens with negative refractive power having an image-side surface being concave;
a second lens with positive refractive power having an image-side surface being convex;
an aperture stop;
a third lens with refractive power having an object-side surface being convex; and
a fourth lens with refractive power;
wherein a thickness of the second lens is CT2, a thickness of the third lens is CT3, an air gap from the second lens to the third lens is AT23, a thickness of the fourth lens is CT4, an air gap from the third lens to the fourth lens is AT34, and the following conditions are satisfied:
$$- 7.3 < ( CT 2 - CT 3 ) / AT 23 < - 0.8 ; and$$
$$- 0.3 < ( CT 3 - CT 4 ) / AT 34 < 1.7 .$$

2. The optical imaging lens of claim 1, wherein a focal length of the the third lens is f3, a focal length of the optical imaging lens is EFL, a focal length of the fourth lens is f4, and the following condition is satisfied:
$$- 3.7 < ( f 3 + f 4 ) / EFL < - 0.02 .$$

3. The optical imaging lens of claim 1, wherein a curvature radius of an object-side surface of the the second lens is R3, a curvature radius of the image-side of the the second lens is R4, and the following condition is satisfied:
$$- 3.1 < R 3 / R 4 < 2.5 .$$

4. The optical imaging lens of claim 1, wherein a focal length of the second lens is f2, a focal length of the optical imaging lens is EFL, and the following condition is satisfied:
$$0.9 < f2 / EFL < 8.8 .$$

5. The optical imaging lens of claim 1, wherein a curvature radius of the image-side of the the second lens is R4, a focal length of the second lens is f2, and the following condition is satisfied:
$$- 1.3 < R 4 / f 2 < - 0.07 .$$

6. The optical imaging lens of claim 1, wherein a curvature radius of an object-side surface of the the second lens is R3, a curvature radius of the image-side of the the second lens is R4, a focal length of the second lens is f2, and the following condition is satisfied:
$$- 0.8 < ( R 3 - R 4 ) / f 2 < 2.8 .$$

7. The optical imaging lens of claim 1, wherein a thickness of the first lens is CT1, a thickness of the second lens is CT2, an air gap from the first lens to the second lens is AT12, and the following condition is satisfied:
$$- 0.4 < ( CT 1 - CT 2 ) / AT 12 < 0.8 .$$

8. The optical imaging lens of claim 1, wherein a focal length of the third lens is f3, a focal length of the optical imaging lens is EFL, and the following condition is satisfied:
$$- 5.5 < f 3 / EFL < 1.8 .$$

9. The optical imaging lens of claim 1, wherein a focal length of the first lens is f1, a focal length of the second lens is f2, a focal length of the optical imaging lens is EFL, and the following condition is satisfied:
$$- 0.1 < ( f 1 + f 2 ) / EFL < 7 .$$

10. The optical imaging lens of claim 1, wherein a total track length of the optical imaging lens is TTL, a thickness of the first lens is CT1, and the following condition is satisfied:
$$4.7 < TTL / CT 1 < 18.$$

11. The optical imaging lens of claim 1, wherein a focal length of the second lens is f2, a maximum image height of the optical imaging lens is ImgH, and the following condition is satisfied:
$$1.7 < f 2 / ImgH < 15.$$

12. The optical imaging lens of claim 1, wherein a focal length of the third lens is f3, a maximum image height of the optical imaging lens is ImgH, and the following condition is satisfied:
$$- 9 < f3 / ImgH < 3.8 .$$

13. The optical imaging lens of claim 1, wherein a maximum image height of the optical imaging lens is ImgH, a focal length of the optical imaging lens is EFL, and the following condition is satisfied:
$$0.4 < ImgH / EFL < 0.8 .$$

14. The optical imaging lens of claim 1, wherein the Abbe number of the first lens is Vd1, the Abbe number of the third lens is Vd3, the Abbe number of the fourth lens is Vd4, and the following condition is satisfied:
$$- 0.7 < ( Vd 3 - Vd 4 ) / Vd 1 < 0.8 .$$

15. The optical imaging lens of claim 1, comprising one of the following conditions to (a) to (e):
(a) wherein an object-side surface of the first lens is convex;
(b) wherein an object-side surface of the second lens is concave;
(c) wherein an image-side surface of the third lens is convex;
(d) wherein the third lens has positive refractive power;
(e) wherein the fourth lens has negative refractive power.

16. The optical imaging lens of claim 15, comprising one of the following conditions:
an object-side surface of the fourth lens being concave;
an image-side surface of the fourth lens being convex.

17. The optical imaging lens of claim 15, comprising one of the following conditions:
an object-side surface of the fourth lens being convex;
an image-side surface of the fourth lens being concave.

18. The optical imaging lens of claim 1, comprising one of the following conditions:
the third lens having negative refractive power;
the fourth lens having positive refractive power;
an object-side surface of the first lens being a flat surface.

19. An imaging device, comprising:
the optical imaging lens of claim 1; and
an electronic image sensor;
wherein the electronic image sensor is located on an image plane of the optical imaging lens.

20. An electronic device, comprising:
the imaging device of claim 19.
